(19) United States
(12) Patent Application Publication
(10) Pub. No.: US 2004/0237331 A1
(43) Pub. Date: Dec. 2, 2004

(54) Intergrated micro-optical and photonics elements batch preparation polishing cleaning and inspection system and method therefore

(76) Inventors: Ory Sarfaty, Ramat Hasharon (IL); Itzchak Ronen, Nirit (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/488,529

(22) PCT Filed: Sep. 2, 2002
(86) PCT No.: PCT/IL02/00724

Related U.S. Application Data
(60) Provisional application No. 60/317,525, filed on Sep. 7, 2001.

(51) Int. Cl. F26B 19/00

(52) U.S. Cl. 34/218

(57) ABSTRACT

The present invention describes a high throughput; high precision integrated, automated micro-optical and photonics elements polishing system for polishing a batch of work-pieces comprising a set-up and preparation station (40) for preparing said batch of work-pieces for polishing, cleaning and inspecting said batch of work-pieces prepared on said preparation station, a robotic arm (46) for moving said batch of work-pieces between said preparation station and said polishing, cleaning and inspection station (38) and within a plurality of positions of said polishing, cleaning and inspection station and a control computer (42) for controlling operation of said polishing system. The present invention also relates to methods for using said systems.

### FIELD OF THE INVENTION

The present invention relates generally to high throughput, high precision integrated micro-optical and photonics elements automated polishing systems. More specifically, the present invention relates to polishing systems for batch preparation polishing, cleaning and inspection micro-optical and photonics elements to sub-micron precision. The present invention also relates to methods for using said systems.

### BACKGROUND

The rapid development of photonics, and in particular optical communications, resulted in the miniaturization of many optical, opto-mechanical and electro-optical devices. The reduction in size of the elements has been accompanied by a sharp increase in production volumes of micro-optical and photonics devices. Production methods of silicon based photonics and planar optical devices have been adopted from the semiconductor manufacturing industry, and support high volume production. However, a large proportion of micro-optical and photonics devices are not planar, are not silicon based and volume production methods for them do not exist. Absence of these high volume production methods for micro-optical devices limits faster growth of the relevant markets.

Polishing is one of the processes used extensively in production of micro-optical and photonics devices. Polished devices include fiber optics wave-guides and micro optical elements such as filters, plain glass plates, fiber optics connectors and others. Historically, polishing is used in a variety of industries, primarily for test and control sample preparation. A typical example of these industries is the metallurgical industry, where samples are prepared for micro-structural analysis. The semiconductor industry polishes wafer cross-sections for inspection under an optical microscope or a scanning electron microscope (SEM). Research and development engineers also utilize polishing to perform cross-section inspections and analysis of silicon wafers during the course of testing new procedures. Analytical laboratories that specialize in micro structural analysis of materials also utilize polishing. In addition, polishing is used extensively in the micro structural analysis of rock, sand, ore, coal and other natural materials. Other applications of polishing include micro-structural analysis of ferrous and non-ferrous materials, printed circuit boards (i.e., the cross-section of copper layers) and advanced materials such as micro-sectioning of ceramics composites, coatings, polymers, etc.

Equipment for these polishing operations exists. The equipment is not adapted, however, for processing of large amounts of samples or work-pieces, which may be fiber optic wave-guides, micro optical elements such as filters, plain glass plates, fiber optic connectors and others. The polishing machines typically accept a single work-piece. Efforts to change this situation have been made in recent years, and some equipment capable of simultaneously processing a few work-pieces has become available. This equipment requires significant operator skills, is characterized by multiple processing stations with manual transfer of the work-piece between them and does not provide satisfactory yields.

In addition, the existing equipment is configured to process a single type of work-piece, e.g. a fiber optic end-surface or a fiber optic ferrule. Control and measurement of the processing results is performed off-line. No on-line feedback is provided to affect the polishing process, or enable rework capability, without removing the work-piece from its gripper or holder. Accuracy of the process suffers also, since multiple mount/dismount steps cannot be iterated.

Forcing a work-piece against a rotating abrasive or abrasive coated surface performs polishing. To get more uniform surface texture sometimes the rotating movement of abrasive or abrasive coated surface is augmented by oscillatory or orbital movement of the work-piece or rotating surface itself. Coordination between these movements is still performed by pure mechanical means and does not support the variety of movements and speeds required by contemporary micro-optical devices and materials.

The work-pieces are typically mounted directly on the polisher with the help of different auxiliary devices. In many cases the start of proper polishing and spatial orientation of the work-piece is a trial and error process. There are no commercially available means for allowing proper a priori work-piece positioning for the polishing process and for the subsequent assessment of polishing process measurement and quality results.

There is a need in the industry for providing a high throughput, high precision automated polishing system capable of processing large batches of a variety of work-pieces with a predefined accuracy and without reliance on highly skilled operators.

### SUMMARY OF THE INVENTION

It therefore is an object of the present invention to provide a high throughput, high precision automated polishing system capable of processing large batches of a variety of work-pieces with a predefined accuracy and without reliance on operator's skills.

It is another object of the present invention to provide a method of polish processing large batches of a variety of work-pieces with a predefined accuracy and without reliance on operator's skills.

In accordance with the present invention, processes required to polish a batch of work-pieces are provided concurrently and independently on a number of stations performing a dedicated set of operations. Examples of such stations may be a preparation station, a polishing station and a robotic arm for moving a batch of work-pieces between a preparation station and a polishing station. A computer may be used for controlling all of the operations of the polishing system.

It is an additional object of the present invention to provide a preparation station for preparing a batch of work-pieces for polishing, comprising means for work-piece spatial orientation and work-piece spatial orientation fixing means, rough polishing performing means, rough polishing results measuring and inspection means and batch identification data coding and communicating means.

A further object of the present invention is to provide work-pieces holding and gripping means enabling its accurate spatial orientation setting, maintaining said spatial orientation through the whole process, and allowing complete portability of a work-piece, or a batch of work-pieces, from one processing station to other.

Still another object of the present invention is to provide integration with the preparation station, rough polishing performing means facilitating, rough polishing results measurement and inspection process guiding said work-piece spatial orientation setting process, sometimes termed as “clocking,” and providing input to batch information data coding and communicating means.

It is yet another object of the present invention to provide a method for using said preparation station for preparing a batch of work-pieces to be polished.

In accordance with the present invention the prepared batch of work-pieces will be moved by robotic or manual means to the polishing station. It is an objective of the present invention to provide a polishing station for polishing, cleaning, rinsing and drying, and inspecting a batch of work-pieces and performing all of the processes by automatically selecting a process recipe from a recipe database. A polishing process where said recipe includes all polishing, cleaning and inspection operations in their optimal sequence, and where the recipe is selected based upon batch information data provided by the preparation station.

It is another object of the present invention to provide a polishing station having a plurality of configurable and interchangeable polishing, cleaning, rinsing and drying, and inspection means flexible enough for accepting a variety of polishing processes defined by different database recipes. A polishing station having mechanical interfaces for accepting a batch work-pieces holding and gripping means, and maintaining their spatial orientation as set at the preparation station.

It is an additional object of the present invention to provide a polishing station having integrated inspection means to inspect and prepare a report on the process batch status and set to provide on-line feedback concerning the progress of the polishing operation.

It is still another object of the present invention to provide a polishing station with digital orbital movement control capable of generating different orbital pattern movements and maintaining track of the orbital pattern movement. A polishing station where said orbital movement pattern improves polishing process results, and improves polishing paper utilization and change frequency by orbiting on previously unused areas of the polishing paper.

It is yet another object of the present invention to provide a polishing station with the polishing mechanism maintaining the same polishing plane of a batch of work-pieces as in the previous polishing stage. The polishing mechanism is capable of continuously monitoring the polishing process advance speed, and maintaining it constant through the whole polishing process. The polishing process advance speed monitoring mechanism monitors deviations of set process advance speed and signals the need for a change of the polishing material.

These and other objectives of the invention may be achieved by providing a batch polishing system comprising: a set-up and preparation station for preparing a batch of work-pieces for polishing; a polishing station for polishing work-pieces prepared on the preparation station batch of work-pieces; a robotic arm for moving batches of work-pieces between the preparation station and a polishing station; and a control computer for controlling operation of the polishing system.

A high throughput high precision integrated, automated micro-optical and photonics elements polishing system for polishing a batch of work-pieces is disclosed comprising;

a set-up and preparation station for preparing said batch of work-pieces for polishing;

at least one station for polishing, cleaning and inspection of said batch of work-pieces prepared on said preparation station;

a robotic arm for moving said batch of work-pieces between said preparation station and said polishing, cleaning and inspection station and within a plurality of positions of said polishing, cleaning and inspection station; and

a control computer connected to all said stations and said robotic arm for controlling operation of said polishing system.

The polishing system preparation station comprises at least one of the following processing means:

batch set-up means for setting up a batch of work-pieces for polishing;

test polishing means for preliminary polishing of said batch of work-pieces to be polished;

batch inspection means for inspecting said preliminary polished batch of work-pieces to be polished;

spatial batch orientation means for positioning in proper spatial orientation said batch of work-pieces to be polished;

batch of work-pieces information generation and coding means for communicating it to said polishing station, and control computer for controlling said preparation station.

The polishing system batch set-up means comprises:

a portable latching turret for moving said batch of work-pieces between different positions;

a removable gripper carrier for holding grippers loaded with work-pieces;

grippers for holding different work-pieces;

work-piece into gripper insertion means for coupling said work-piece with said gripper;

micrometric gripper orientation adjustment means for assisting in

work-piece spatial orientation process, and

said inspection means for facilitating work-piece orientation

The polishing system removable gripper carrier comprises multiple grippers for holding different work-pieces.

The system, wherein said removable gripper carrier comprises separate and suspended, floating gripper mounts.

The polishing system, wherein said separate and suspended gripper mounts are attachable to a portable latching turret assembly.

The polishing system, wherein said portable latching turret assembly comprises:

a floating part holding said batch of work-pieces to be polished, and

a rigid part coupled for handling and polishing to said robotic arm.

The polishing system, wherein said portable latching turret assembly is a rigid portable latching turret assembly.

The polishing system, wherein said portable latching turret assembly is a floating portable latching turret assembly.

The polishing system, wherein said portable latching turret assembly maintains said batch of work-pieces spatial orientation constant through the whole process.

The polishing system, wherein said at least one of the polishing, cleaning and inspection stations comprise at least one of the following:

a batch of work-pieces holding and moving means, for holding said batch of work-pieces for auxiliary and operational movements;

a polishing unit for polishing said batch of work-pieces;

a cleaning unit for cleaning said batch of polished work-pieces;

a rinsing and drying unit for rinsing and drying said batch of polished work-pieces;

an inspection unit for inspecting said batch of polished work-pieces;

a digital orbiting movement control unit for orbital movement of said batch of polished work-pieces;

a batch of work-pieces holding means descend speed control means for controlling descend speed of said batch of polished work-pieces;

a force maintenance and monitoring unit for limiting said polishing force applied to said batch of polished work-pieces;

a recipe database for storing and selecting processes to be run on the system;

a SPC type reporting means for reporting results of said polished batch inspection, and

a control computer, for controlling operation of the system.

The polishing system having said at least one of the polishing, cleaning and inspection stations, wherein said batch of work-pieces holding and moving means are digitally controlled and positioned by linearly moving X-Y-Z stages.

The polishing system having said at least one of the polishing, cleaning, and inspection stations, wherein said linearly moving X-Y-Z stages perform both auxiliary and operational movements.

The polishing system having said at least one of the polishing, cleaning and inspection stations, wherein said digital orbiting movement control unit creates orbital movement by simultaneously changing polished batch advance speed along X and Y movement stages, and wherein the speed of said X and Y stages may be not equal.

The polishing system having said at least one of the polishing, cleaning and inspection stations, wherein said digital orbital movement pattern is achieved by setting the ration between advance speed along X and Y movement stages.

The polishing system having said at least one of the polishing, cleaning and inspection stations, wherein said polishing unit, said cleaning unit and said rinsing and drying have common external dimensions and their position and order are interchangeable.

The polishing system having said at least one of the polishing, cleaning and inspection stations, wherein said polishing, cleaning and inspection processes are performed in accordance with said process recipes, and wherein said recipes are stored in a data base.

The polishing system having said at least one of the polishing, cleaning and inspection stations to according, wherein said process recipes database is a hierarchical one comprising:

families, said families including components with similar properties;

components said components characterizing particular work-pieces, and

a plurality of process recipes said recipes containing components processing parameters.

The polishing system according having said at least one of the polishing, cleaning and inspection stations, and where said polishing, cleaning and inspection processes recipes are selected in accordance with said batch identification code assigned at said preparation station.

The polishing system having said at least one of the polishing, cleaning and inspection stations, and where said inspection means comprise:

at least one angle measurement device for measuring polished work-piece angle;

at least one microscope for inspecting polished surface and measuring linear dimensions, and

at least one interferometer for measuring polished surface roughness.

The polishing system having the at least one of the polishing, cleaning and inspection stations and where said at least one angle measurement device for measuring polished work-piece angle is a laser measurement device.

The polishing system having said at least one of the polishing, cleaning and inspection stations, and where said angle measurement is performed by measuring a reflected laser beam from the surface of a rotating polished work-piece.

The polishing system having said at least one of the polishing, cleaning and inspection stations, and where said at least one microscope for inspecting polished surface and measuring linear dimensions has bright and dark field illumination and video camera.

The polishing system having said at least one of the polishing, cleaning and inspection stations, and where said at least one microscope is focused automatically on said polished work-piece surface.

The polishing system having said at least one of the polishing, cleaning and inspection stations, and where said at least one microscope is focused automatically concurrently with work-piece surface inspection process.

The polishing system having said at least one of the polishing, cleaning and inspection stations, wherein said polishing removal rate is controlled by measuring the descent speed of a batch of work-pieces being polished

The polishing system having said at least one of the polishing, cleaning and inspection stations, wherein said force maintenance and monitoring unit limits value of polishing force applied to polished batch of work-pieces.

A method of processing a batch of work-pieces of micro-optical and photonics elements for polishing preparation, comprising the further steps of

inserting each of said work-pieces into respective gripper;

mounting each said gripper on a removable gripper carrier and portable latching turret;

moving said portable latching turret with said batch of work-pieces to preparation station;

making rough polishing of said batch of work-pieces;

providing desired spatial orientation for clocking to said rough

polished batch of work-pieces and placing their respective polished surfaces in one plane; and

generating batch identification information describing said rough polished batch of work-pieces;

wherein said batch identification information describing said rough polished batch is used for further batch processing steps.

A method of processing a batch of work-pieces of micro-optical and photonics elements for polishing, cleaning, inspecting and providing a statistical process control (SPC) report, comprising the further steps of

preparing said batch of work-pieces to be polished on said preparation station;

moving said prepared batch of work-pieces to be polished to said polishing, cleaning and inspection station;

communicating/transferring said prepared batch of work-pieces identification information to said polishing, cleaning and inspection station;

selecting polishing process recipe for polishing said prepared batch of work-pieces in accordance said batch identification information;

selecting cleaning recipe for cleaning said polished batch of work-pieces in accordance with said batch identification information;

selecting rinsing and drying recipe for rinsing and drying said polished and cleaned batch of work-pieces in accordance said batch identification information;

inspecting said rinsed and dried batch of work-pieces in accordance said batch identification information, and

providing a pass-fail and SPC report of said inspected batch of work-pieces.

A method of processing a batch of micro-optical and photonics elements polishing with removal rate control, comprising the further steps of

preparing said batch of work-pieces to be polished on said preparation station;

moving said prepared batch of work-pieces to be polished to said polishing station;

transferring said prepared batch of work-pieces information to said polishing station; and

selecting polishing recipe for polishing said prepared batch of work-pieces in accordance said batch identification information,

wherein the material removal rate is controlled by said batch of work-pieces descend speed control.

A method of polishing material exchange on a polishing system including polishing, cleaning and inspection stations, said method comprising the further steps of

positioning a batch of work-pieces to be polished using a polishing material;

polishing said batch of work-pieces on said polishing material;

monitoring and controlling the linear advance speed of the paired holding means of the work-pieces of said batch of work-pieces; and

setting an optimal range the linear advance speed of the paired

holding means of the work-pieces of said batch of work-pieces,

wherein said polishing material change is performed when said batch of work-pieces holding means linear advance speed deviation, exceeds a preset linear advance speed range.

A method of processing a batch of work-pieces comprising micro-optical and photonics elements, which are polished and undergo SPC reporting on a polishing system including preparation, polishing, cleaning and inspection stations, said method comprising the further steps of

preparing said batch of work-pieces to be polished on said preparation station;

polishing said prepared batch of work-pieces to be processed on said polishing, cleaning and inspection stations;

cleaning said polished batch of work-pieces on said cleaning station; and

inspecting said cleaned batch of work-pieces on said inspection station,

wherein said SPC report is prepared on-line in accordance with the batch of work-piece inspection results.

A method of processing a batch of work-pieces of micro-optical and photonics elements on a polishing preparation station having a plurality of grippers on a removable gripper carrier and a portable latching turret, said method comprising the further steps of

inserting each of said work-pieces into a respective gripper of said

plurality grippers of said removable gripper carrier;

mounting each said gripper on said removable gripper carrier and said portable latching turret;

moving said portable latching turret with said batch of work-pieces to said preparation station;

rough polishing of said batch of work-pieces;

providing the desired spatial orientation for clocking of said rough polished batch of work-pieces and placing their respective polished surfaces in one plane;

generating batch identification information describing said rough polished batch of work-pieces,

wherein said batch identification information describing said rough polished batch is used for further batch processing steps; and

using a multiple of said plurality of grippers for different work-pieces with said one removable gripper carrier.

The method of processing, comprising the further step of inspecting and analyzing said images.

The method of processing, comprising the further step of measuring the polishing angle.

The method of processing, comprising the further step of measuring and analyzing said images.

The method of processing, comprising the further steps of:

applying a database of experience;

using all of the polishing disk area; and

regulating the polishing speed accordingly.

The method of processing, and wherein said removable gripper carrier uses separate and suspended gripper mounts.

The method of processing, and wherein the particular invention reduces the number of changes in removable gripper carrier structure by making grippers, holding different form work-pieces, with an identical gripper mounting part.

The method of processing, and wherein the first rough polishing is made in a rigid mode of operation and the subsequent polishing steps are made in a floating mode of operation.

The method of processing, and wherein the preparation for polishing for all polished surfaces are brought in the same plane.

A polishing batch preparation station is also provided comprising a top part (body), and mounted on it a batch set-up means, batch test polishing means, batch inspection means and batch information data coding means. The preparation station where each work-piece of a batch of work-pieces to be processed is mounted in an individual gripper and all work-pieces of the batch are mounted on a removable gripper carrier.

A preparation station is also provided where each work-piece of the batch set up is spatially oriented and locked (“clocked”) in a desired position on a removable gripper carrier. A preparation station where the individual work-piece position is established with the help of inspection means, and where the batch identification data is recorded in digital form and communicated to the polishing station.

A removable gripper carrier is also provided capable of holding multiple grippers with different work-pieces, and with separate and suspended gripper mounts attachable to a portable latching turret assembly, and is easily portable from one process station to another. A portable latching turret is capable of operating in floating, or rigid mode of operation when mounted on a polishing station.

A polishing station is also provided with a plurality of polishing units, cleaning units, rinsing and drying unit, inspection unit, digital orbiting movement control, force maintenance and monitoring unit, recipe database and statistical process control (SPC) type reporting means.

A polishing station is also provided where the polishing units, cleaning units and rinsing and drying unit have identical dimensions and the electrical connections are interchangeable. A polishing station where batch processing is defined by a recipe, comprising one of a plurality of recipes stored in a database, and optimized for processing of a particular batch with identification data originating at a preparation station.

A polishing station is also provided with batch inspection means and SPC type reporting and work-piece classification (binning) based on the results of polished batch inspection and image analysis.

A polishing station is also provided where digital orbital movement control enables positioning of a batch of work-pieces 62 to be polished on any area of polishing disk, saving polishing paper by using all of the polishing disk area and improving polishing speed accordingly.

### BRIEF DESCRIPTION OF THE DRAWINGS

The foregoing aspects and many other advantages of this invention will become more readily appreciated, as the same becomes better understood by reference to the following description, when taken associated with accompanied drawings, which are schematics of different units and methods of the invention.

FIG. 1 is a schematic block diagram of a high throughput; high precision, integrated, automated micro-optical and photonics elements polishing system constructed in accordance with the principles of the present invention;

FIG. 2 is an illustration of the top view of the preparation station, which is part of the high throughput, high precision integrated, automated micro-optical and photonics elements polishing system of the present invention;

FIG. 3 is an illustration of the front view of the preparation station, which is part of the high throughput, high precision integrated, automated micro-optical and photonics elements polishing system of the present invention;

FIG. 4 is a schematic illustration of a polishing unit of the preparation station of the present invention;

FIG. 5 is an expansion of a schematic illustration of the polishing unit of the preparation station;

FIG. 6 is a schematic illustration of a rotating fixture of the preparation station of the present invention;

FIG. 7 is a schematic illustration of the mounting of the rotating fixture of FIG. 6 of the preparation station of the present invention;

FIG. 8 is a schematic illustration of the relative position of the polishing unit, rotating fixture and inspection unit of preparation station of present invention;

FIG. 9 is a schematic illustration of an exemplary construction of the removable gripper carrier;

FIG. 10 is a schematic illustration of another exemplary construction of the removable gripper carrier;

FIG. 11 is an assembly of the exemplary construction of the removable gripper carrier of FIG. 10 with the floating gripper holders of FIG. 12;

FIG. 12 is an expansion of area C-C of the assembly of FIG. 11;

FIG. 13 is a schematic illustration, in detail, of an exemplary floating gripper holder of removable gripper carrier of FIG. 10;

FIG. 14 is an illustration of another exemplary construction of removable gripper carrier with gripper holders adapted for holding long and flat work-pieces;

FIG. 15A, 15B, and 15C show exemplary construction of work-piece grippers;

FIGS. 16A and 16B are illustrations of a work-piece into gripper insertion device, which is part of the preparation station of the polishing system of the present invention;

FIGS. 17A, 17B, and 17C show exemplary portable latching turret assemblies, which are part of the preparation station of the polishing system of the present invention;

FIG. 18 is a schematic illustration of the construction of the portable latching turret assembly of the polishing system of the present invention;

FIGS. 19A and 19B are front and side views of the inspection and measurement unit of the preparation station of the polishing system of the present invention;

FIG. 20 illustrates the micrometric gripper adjustment mechanism of the preparation station of present invention;

FIG. 21 is an illustration of the top view of the polishing station of a high throughput, high precision integrated, automated micro-optical and photonics elements polishing system of the present invention;

FIG. 22 is a schematic front view of the polishing station of a high throughput, high precision integrated, automated micro-optical and photonics elements polishing system of the present invention;

FIG. 23 is an illustration of a rear view of the polishing station of a high throughput, high precision integrated, automated micro-optical and photonics elements polishing system of the present invention;

FIG. 24 is a schematic illustration of a polishing unit of the polishing station of the present invention;

FIG. 25 is a schematic illustration of a cleaning unit of the polishing station of the present invention;

FIG. 26 is a schematic illustration of a rinsing and drying unit of the polishing station of the present invention;

FIG. 27 is a three dimensional schematic illustration of another embodiment of a rinsing and drying unit of the polishing station of the present invention;

FIG. 28 is an illustration of the polishing force control and monitoring mechanism;

FIG. 29 is a schematic representation of the paper change indication point, which uses polishing batch descent speed measurement;

FIG. 30 is an illustration of Z-direction stage construction;

FIG. 31 is a schematic representation of the computer generated orbital movement pattern of the removable gripper carrier holding a batch of work-pieces;

FIG. 32 is an illustration of the inspection unit of the polishing station of the present invention;

FIG. 33 is a cut through view of the polishing station of the present invention showing the integrated inspection unit;

FIGS. 34A and 34B are respectively illustrations of an exemplary calibrated image of the polished fiber tip/end-face and of another exemplary calibrated image of a part of the polished edge of a silicon arrayed wave guide grating (AWG);

FIGS. 35A and 35B are schematic illustrations of the polished angle measurement unit of the polishing station of the present invention;

FIG. 36 is a schematic illustration of another method of the polished angle measurement, which is a part of the present invention;

FIG. 37 is block diagram illustrating the recipe database structure and its parameters;

FIG. 38 is a schematic of high-level flowchart showing the system set up, polishing, cleaning, inspection, inspection and report generation processes;

FIG. 39 is a high-level flow chart of the processes performed on the preparation station;

FIG. 40 is a schematic illustration of the work-piece clocking process performed with the help of the inspection unit of the preparation station;

FIG. 41 is a schematic expansion showing in more detail the flow chart of polishing process, cleaning process, and initial stages of the inspection process and the sequence in which they are performed on the polishing station;

FIG. 42 is a schematic expansion showing in more detail the flow chart of the initial stages of the inspection processes and the sequence in which they are performed on the polishing station;

FIG. 43 is a high-level flowchart showing the inspection process steps and algorithm; and

FIG. 44 is an illustration of the active areas on a fiber image.

### DETAILED DESCRIPTION OF EXEMPLARY EMBODIMENTS

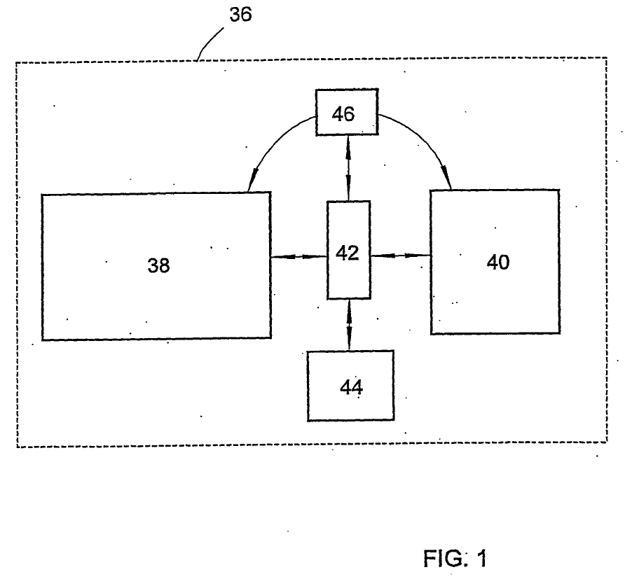

The high throughput, high precision integrated, automated micro-optical and photonics elements polishing system 36 shown in FIG. 1 may include a polishing station 38 and a preparation station 40. Control computer 42 governs the operation of both polishing station 38 and preparation station 40. Alternatively, each of the stations may have a dedicated computer. In this case, the distributed computers would communicate between themselves via a network.

Computer 42 may: control all polishing system processes, such as the inspection processes; perform statistical process analysis; maintain process and parts databases; and issue different reports. Additionally, control computer 42 may contain programs providing for process learning capabilities. The learning capabilities support the continuous improvement of the polishing process. They may identify process degradation parameters and indicate reasons for the process degradation

An operator stand 44, with a monitor and a Graphic User Interface (GUI), allows interactive operator intervention into each stage of the process. Control computer 42 uses the monitor with a GUI to display a process status and to provide the operator with other useful information and images of the work-pieces being processed. An optional robotic arm 46 for transfer of work pieces between the preparation station and polishing station may also be included in high throughput, high precision automated polishing system 36.

The following description provides detailed information on some of the main components of a high throughput; high precision integrated, automated micro-optical and photonics elements polishing system of the present invention. The description follows a typical workflow pattern.

Preparation Station

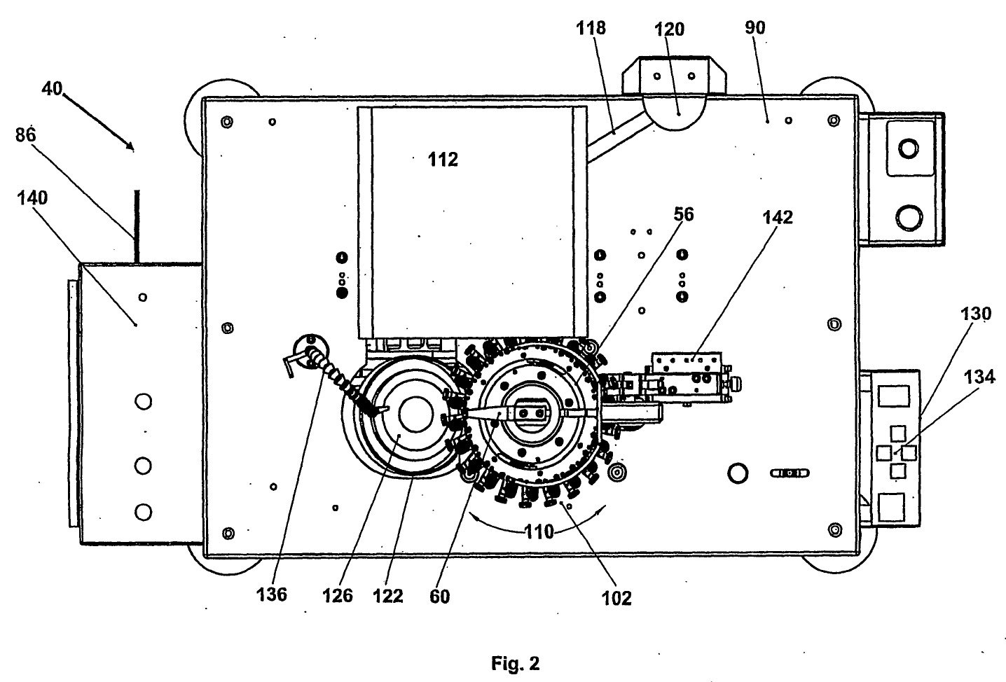

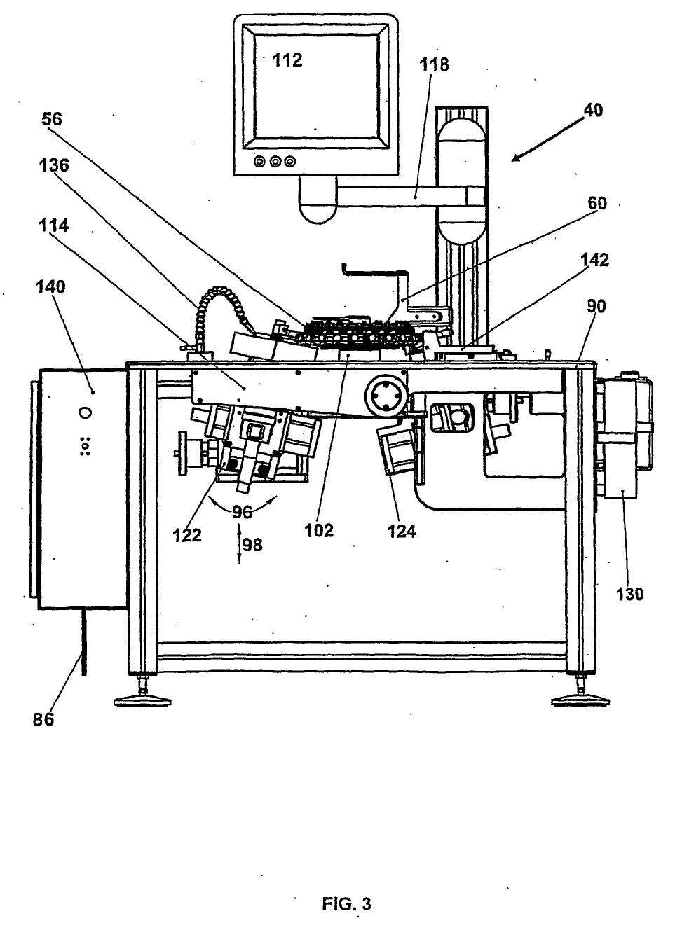

Preparation station 40, which is a part of high throughput, high precision integrated, automated micro-optical and photonics elements polishing system 36 of the present invention, is shown in FIGS. 2 and 3. Preparation station 40 enables setting of a complete batch of work-pieces into identical spatial positions that ensure identical processing conditions for all work-pieces in the batch. In addition to this, preparation station 40 provides for removal of undesired materials such, as residuals of epoxy, which is used for fiber to ferrule adherence. Preparation station 40 further provides for: control of the spatial orientation of the particular work-piece; correction of the orientation; and setup data communication to other processes within and outside of polishing system 36.

Several attachments may be made on the top part 90 of preparation station 40, as shown in FIG. 2. These exemplary attachments include a preliminary rough polishing unit 122 and a rotating fixture 102, shown covered with a generalized removable gripper carrier 56 and a portable latching turret assembly 60. Additionally, on the same top surface 90 of preparation station 40 may be positioned an inspection unit 124, as shown in FIG. 3, and a micrometric gripper adjustment mechanism 142. Alongside preparation station 40, and on the level of surface 90, is an operator's panel 130, with knobs and switches controlling some of the units of preparation station 40. An electric drive, which is not shown and which impels rotating fixture 102, is positioned behind protective housing 114 which is shown in FIG. 3. Control computer 42 (see FIG. 1) controls the electric drive, and, respectively all of the movements of rotating fixture 102, shown covered in both FIGS. 2 and 3 by portable latching turret 60. Joystick type control 134, shown in FIG. 2, provides for adjustment of the rotational movement of rotating fixture 102. Rotating fixture 102 may rotate continuously or move in step-wise rotational movements, with typical step corresponding to the distance between grippers on generalized removable gripper carrier 56. Station control supports both clockwise and counter clockwise rotational movements of rotating fixture 102, as indicated by arrows 110. Other knobs control operator-initiated movements of preliminary rough polishing unit 122 and inspection unit 124 (FIG. 3). Operator's monitor 112 may be mounted with help of an arm 118, shown in swing position relative to axis 120, over preparation top part 90 of preparation station 40. Operator monitor 44 may serve to display images captured at preparation station 40, although typically preparation station 40 has a dedicated display 112. Box 140 contains preparation station control electronics.

Control computer 42 (see FIG. 1) may control preparation station 40. Dedicated cable 86 (FIGS. 2, 3 and 22) connects control computer 42 residing in polishing station 38 of preparation station 40. Alternatively, a stand-alone computer (not shown), communicating on a network with computer 42, may control preparation station 40. A marking and coding module, primarily comprising software, and hardware if necessary, may be part of preparation station 40. A box 140 contains electronics boards that control preparation station 40, as well as communication interfaces with other stations of high throughput, high precision integrated, automated micro-optical and photonics elements polishing system 36 of the present invention.

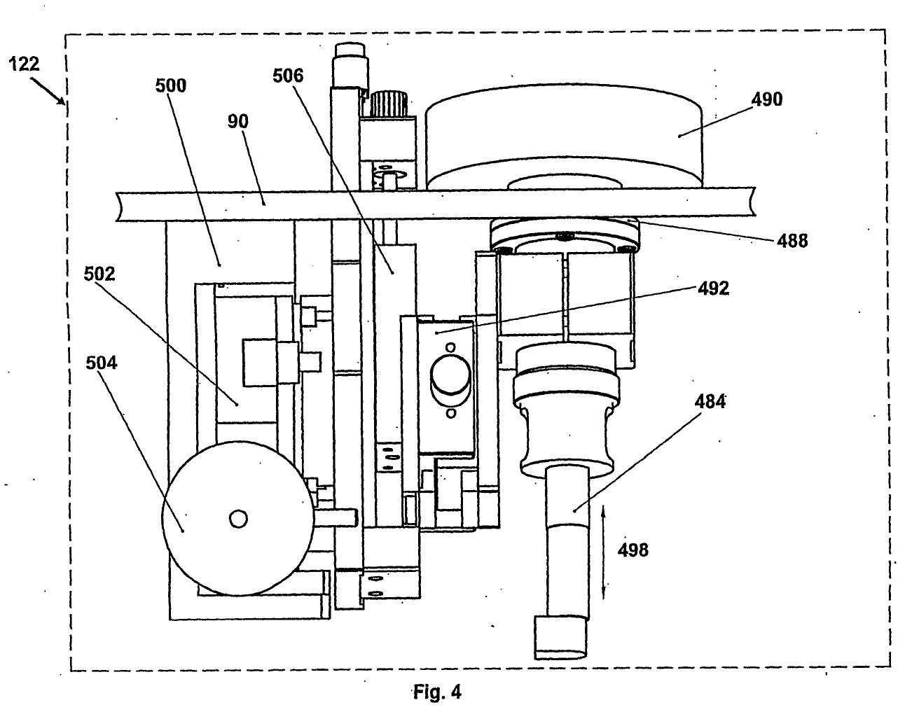

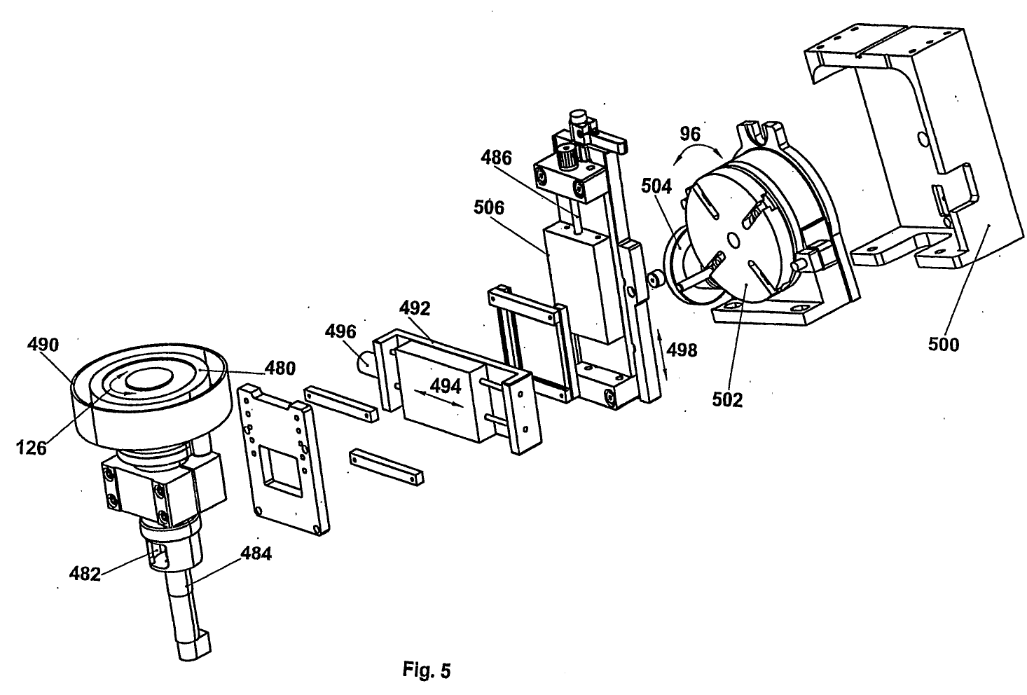

Some of the units included in preparation station 40 are now disclosed in detail. FIG. 4 is a schematic illustration of the assembly of rough preliminary polishing unit 122, which is part of the construction of preparation station 40. FIG. 5 is an expansion of a schematic illustration of rough preliminary polishing unit 122 of the preparation station. Rough preliminary polishing unit 122 includes a polishing disk 480 (see FIG. 5) on which different grits of polishing paper may be placed. Polishing disk 480 is coupled by means of coupling 482 to the axis of a DC brushless electric motor 484. A waterproof gasket 488 seals the motor-disk assembly to a protective stainless steel basin 490. (see FIG. 4) A fluid dispenser 136 (FIGS. 2 and 3) delivers cooling fluid into basin 490. Polishing unit 122 has variable rotational speed. The rotational speed of polishing unit 122 varies in a range of 10 to 300 rpm, allowing an optimal combination of polishing speed and material removal rate for work-pieces made of different materials. Polishing disk 480 may rotate in both clockwise and counter clockwise directions. The complete motor-polishing disk assembly is mounted on guides 492 and 506. A screw (not shown) driven by a motor 496, may move the complete motor-polishing disk assembly in the axial direction indicated by arrow 494. Screw 486 drives guides 506. Rotation of screw 486 drives complete motor-polishing disk assembly in direction of arrows 498. Guides 506 are further mounted on a support 502. Complete preliminary rough polishing unit assembly has further angular rotational freedom with respect to support 500, and may swing/incline in the direction indicated by arrow 96 (FIGS. 2 and 5). Operation of handle 504 inclines rough polishing unit 122. Inclination of rough polishing unit 122 with respect to support 500 establishes the work-piece preliminary rough polishing angle.

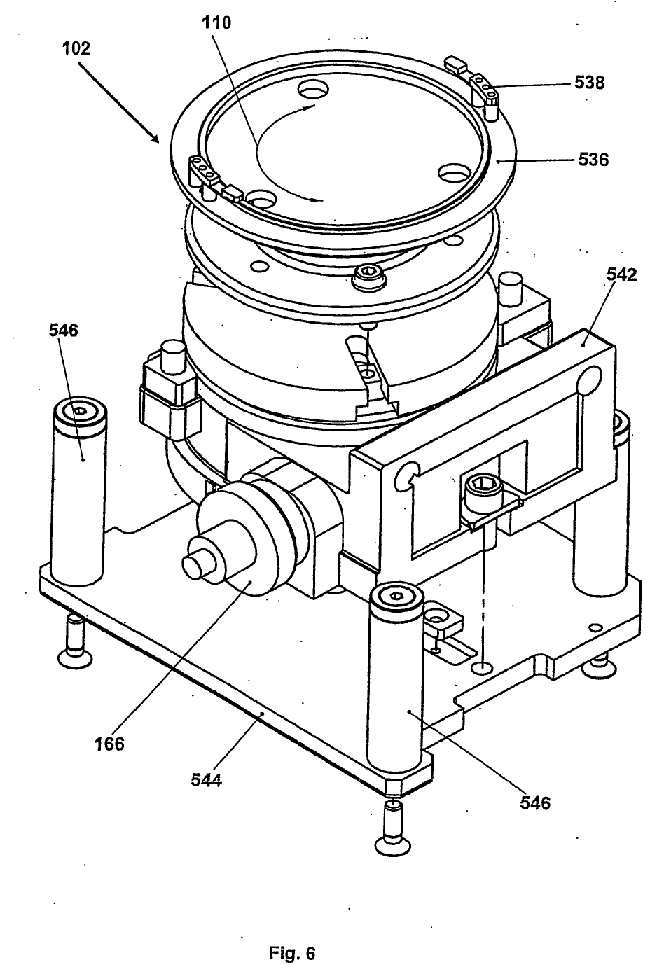

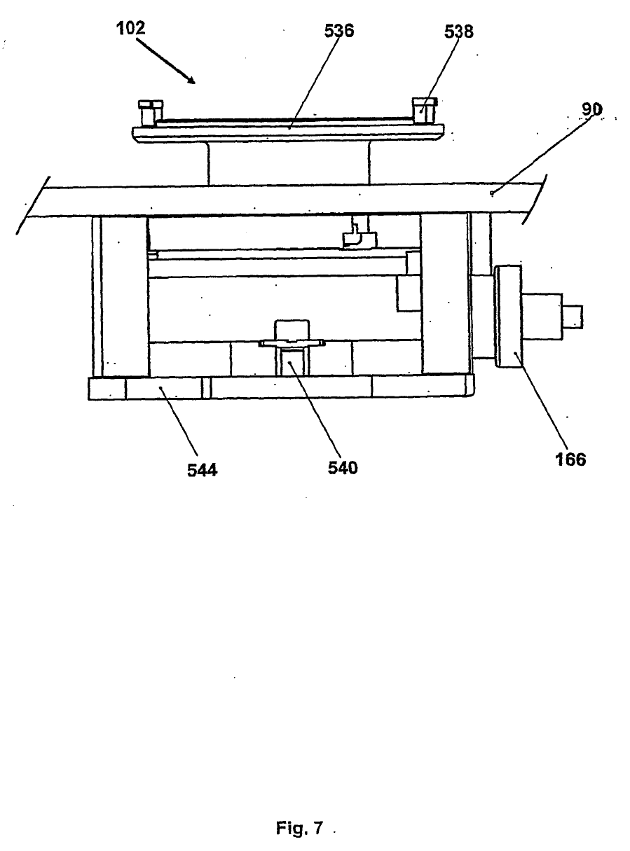

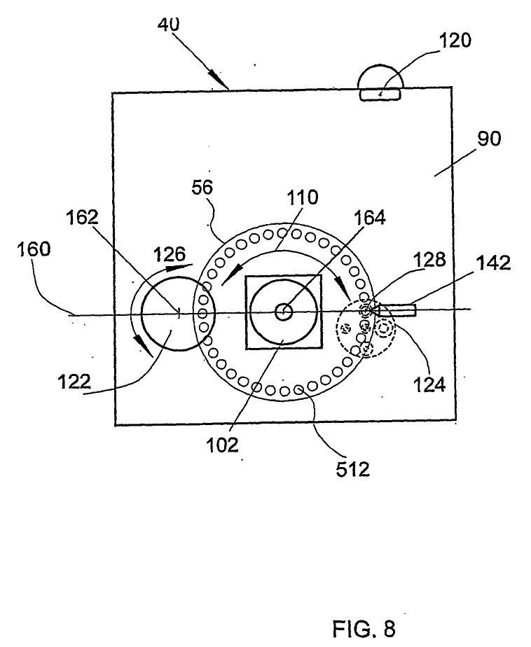

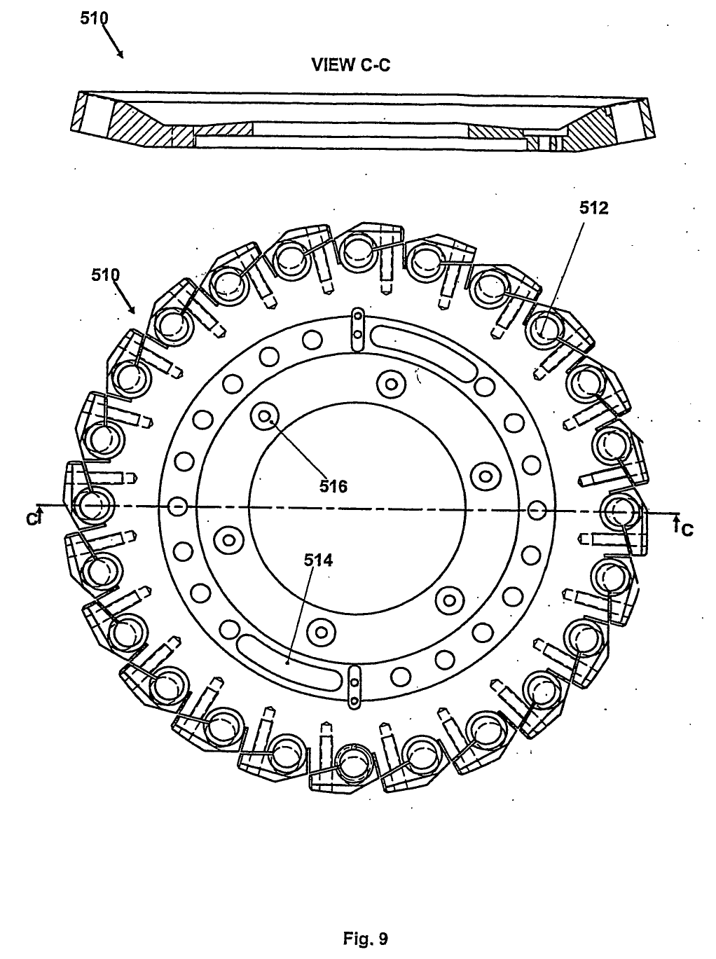

FIG. 6 is a schematic illustration of a rotating fixture 102 of preparation station 40 of the present invention. Rotating fixture 102 includes an accurate machined disk 536 with bayonet-type locking pins 538. Bayonet locking pins 538 hold and fix the position of removable gripper carrier 56 (FIGS. 2 and 3). Disk 536 rotates on an axis 540 (FIG. 7). Electric drive (not shown) positioned behind protective housing 114 (FIG. 3) drives axis 540 and disk 536. Encoder 166 provides an input to control of the electrical drive 144 of fixture 102. Control of electrical drive enables continuous and stepwise rotational movement of disk 536 with generalized removable gripper carrier 56 (not shown). Each step of the stepwise rotational movement of disk 536 with generalized removable gripper carrier 56 (FIGS. 2 and 3) is equal to the angular distance between gripper holder holes 512 (FIGS. 8 and 9), in which work-pieces 62 (not shown in FIG. 6) are each mounted in their individual and proprietary holders, chucks or grippers. Both the continuous rotational movement, and stepwise rotational movement, may be in clockwise or counter clockwise directions, as indicated by arrow 110. Joystick type control 134 (FIG. 2) facilitates operator initiated continuous and stepwise manual rotational movement of disk 536 with generalized removable gripper carrier 56 (FIGS. 2 and 3) and portable latching turret 60 (not shown). FIG. 7 is a schematic illustration of the mounting of rotating fixture 102 of FIG. 6 of the preparation station 40 of the present invention. For the convenience of mounting grippers on gripper carrier 56, joystick 134 (FIG. 2) controls disk 536 movements. Alternatively, removable gripper carrier 56 may be loaded by grippers off-line, and later mounted on the preparation station for the orientation and pre-polishing processes.

Brackets 542 attach disk 536 with axis 540 to plate 544. Four columns 546, as shown in FIG. 6 and 7, attach the assembly to upper part 90 of preparation station 40.

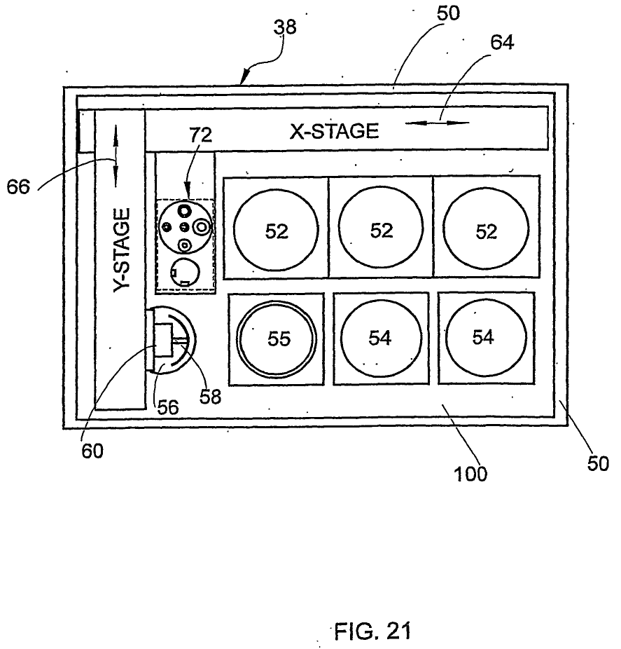

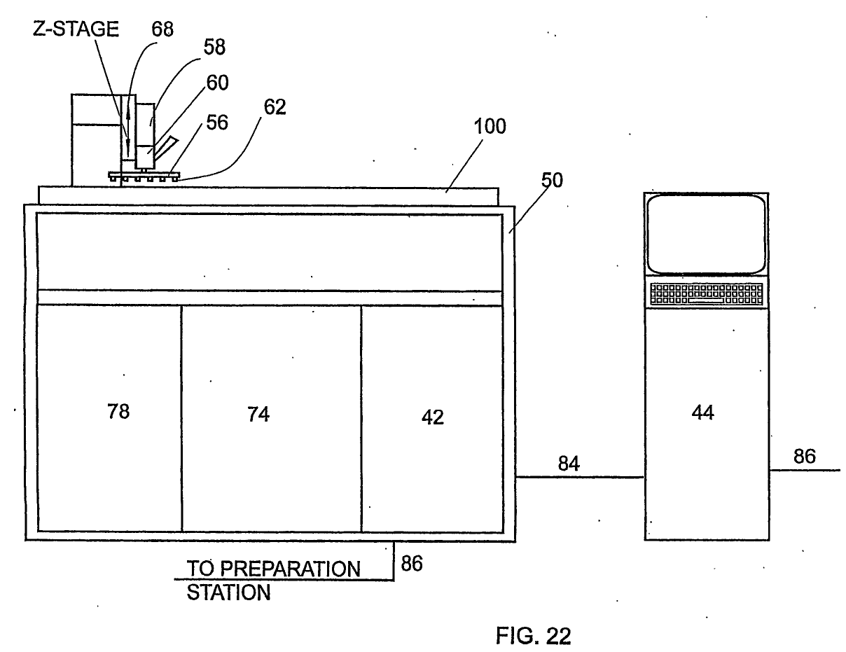

FIG. 8 is a schematic illustration of the relative position of the polishing unit 122, rotating fixture 102 and inspection unit 124 of the preparation station of the present invention. Rotating fixture 102 is fixedly mounted on top of preparation station 40. Generalized removable gripper carrier 56 (shown in thin lines), holding work-pieces 62 (shown only in FIG. 22), rotates around the same axis 164 as rotating fixture 102. The position of rotation axis 162 of rough preliminary polishing unit 122, the position of the optical axis of active microscope 128 of inspection system 124 (shown in phantom lines) and micrometric adjustment mechanism 142 gripper contact point lie essentially on the same line 160. Since both rough preliminary polishing unit 122 and inspection system 124 have substantially all degrees of freedom of movement, they may be realigned periodically as required. Typically, realignment may be necessary when the type of removable gripper carrier is changed. Holes 512 mark gripper mounting holes.

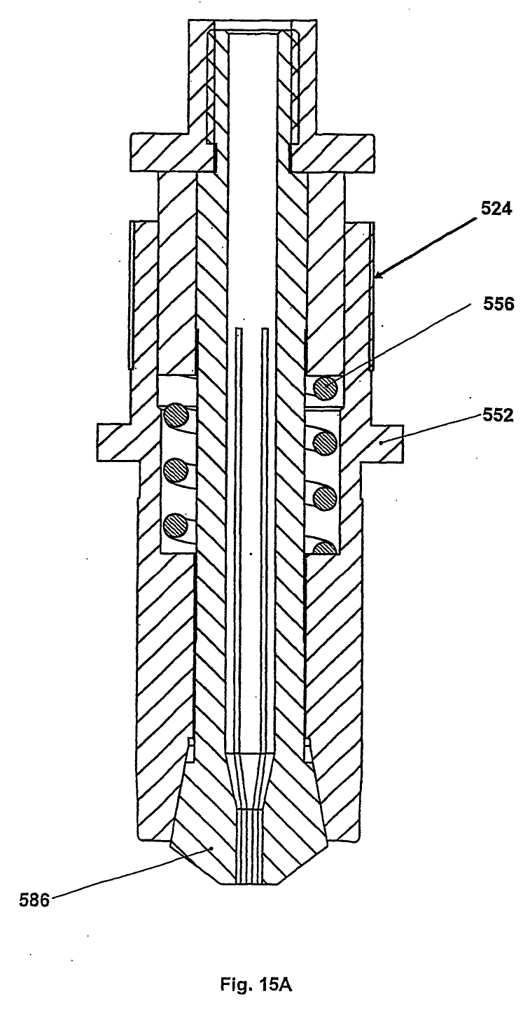

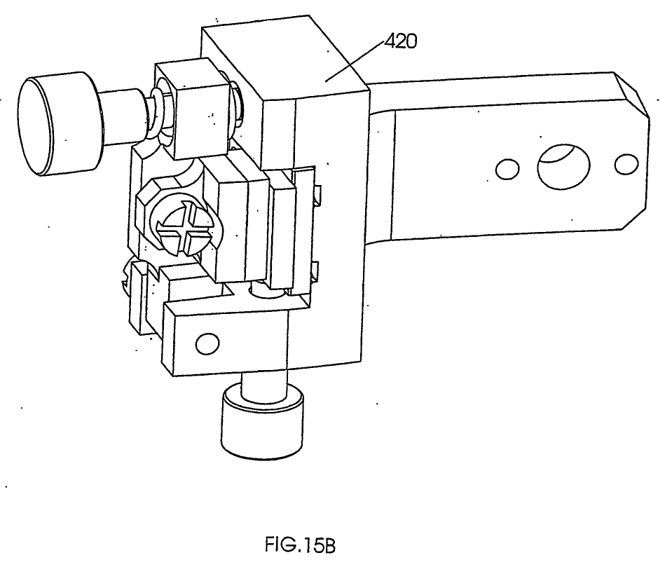

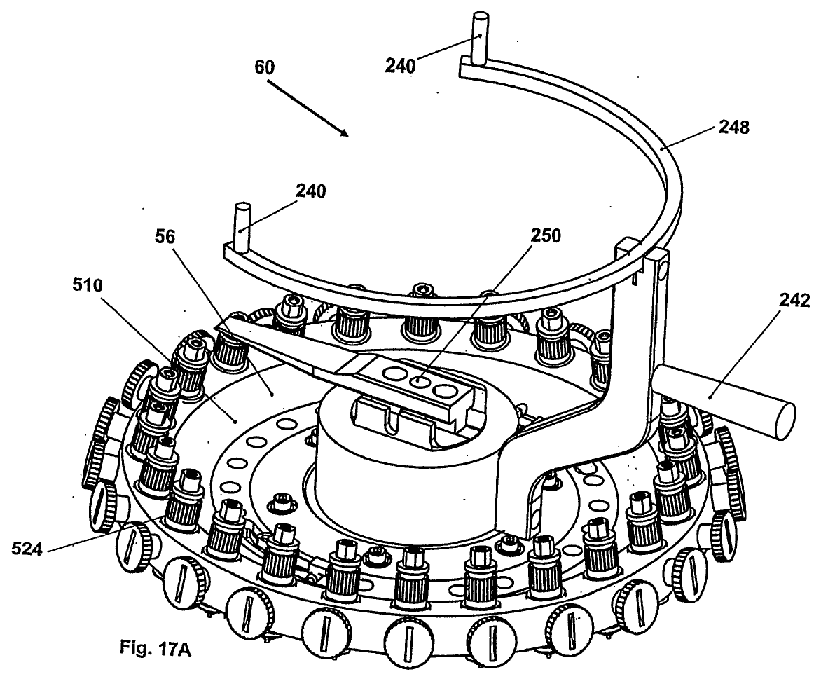

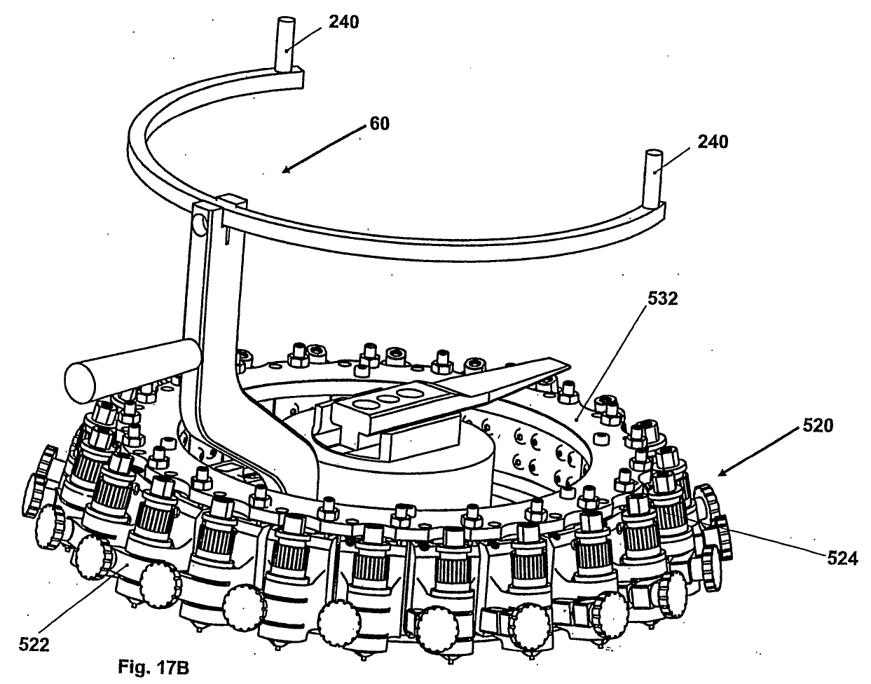

FIG. 9 shows an exemplary construction of a first removable gripper carrier 510. Generalized removable gripper carrier 56 facilitates coupling between disk 536 (FIG. 6) on one side and portable latching turret assembly 60 (not shown in FIG. 9, but shown in FIG. 3 and FIG. 17) on the other side. Generalized removable gripper carrier 56 holds all grippers with work-pieces. Its form and size may change according to the work-piece held. The present invention, in particular, reduces the number of changes needed in the removable gripper carrier structure, by making the grippers, which hold work-pieces of different form, albeit with an identical gripper mounting part (see FIGS. 15A and 15B).

Typically, a gripper or a chuck holds a work-piece 62 (see FIG. 22). Work-pieces 62 may be fiber optics wave-guides, micro-optical elements such as filters, plain glass plates, V-groves, fiber optics connectors, Arrayed Waveguide Gratings (AWG) and others. Each gripper, with the work-piece it holds, is inserted into gripper mounting hole 512 of first exemplary removable gripper carrier 510 and locked in it by any known locking means. First exemplary removable gripper carrier 510 may hold a large number of grippers such as 24 or 32 grippers. Generalized removable gripper carriers holding a larger or smaller amount of grippers or work-pieces may be set on preparation station 40. Bayonet-type holes 514 engaging with bayonet locks 538 (FIGS. 6 and 7) enable fast and easy attachment of first exemplary removable gripper carrier 510 to disk 536 of rotating fixture 102 of preparation station 40 (FIGS. 2 and 3). Holes 516, are used to mount first exemplary removable gripper carrier 510 to portable latching turret assembly 60 (not shown). First exemplary removable gripper carrier 510 may be used to hold a number of different grippers or chucks, although it is preferable to stuff first exemplary removable gripper carrier 510 with homogeneous work-pieces.

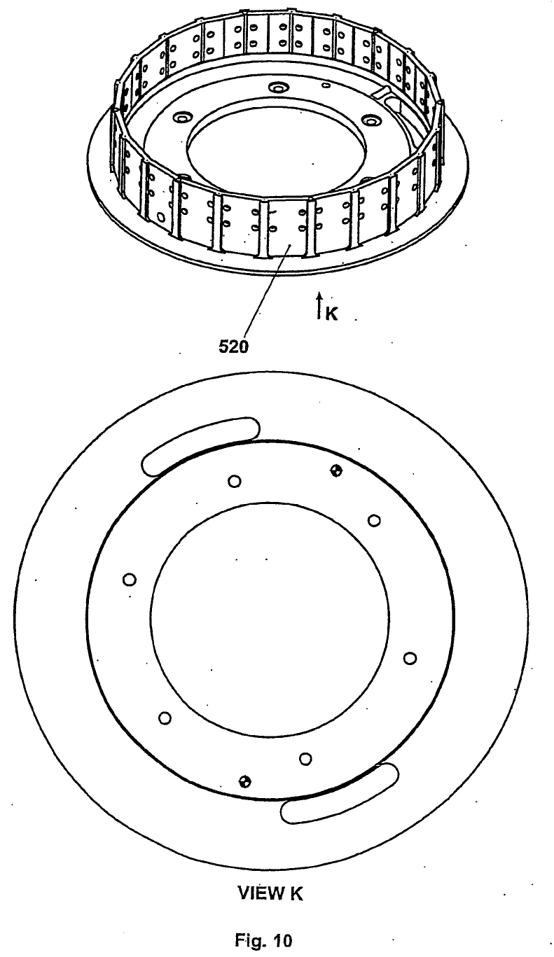

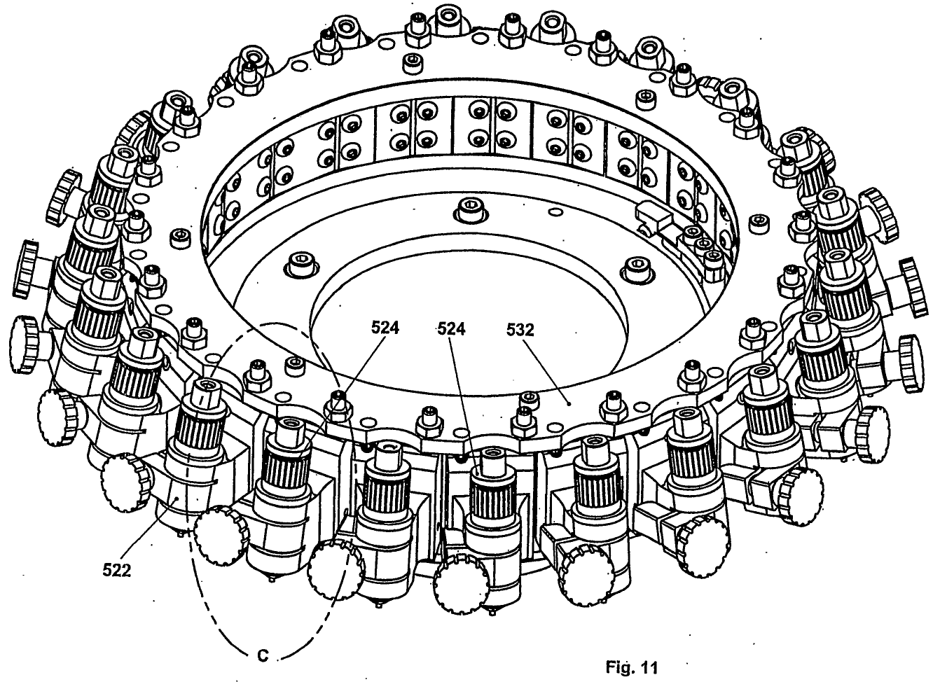

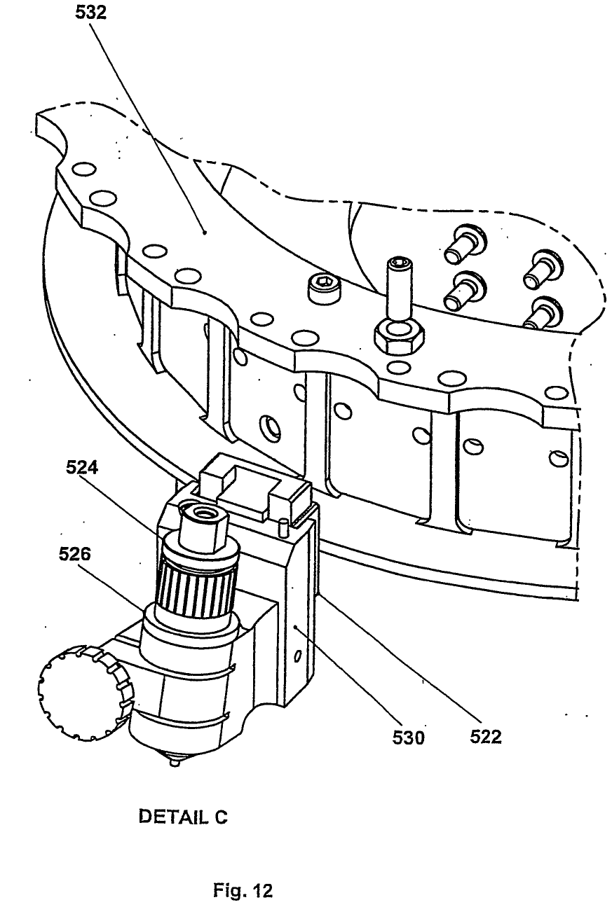

FIG. 10 shows a perspective view and a bottom view of a second exemplary construction of removable gripper carrier 520. Second exemplary removable gripper carrier 520, instead of having a plurality of mounting holes, holds separate gripper holders 522, as shown in FIG. 11. Gripper holders 522 may be of regular or floating construction. Particular gripper holder 522 is of floating construction. Each gripper 524, with the work-piece it holds, is inserted into a single mounting hole 526 (see FIG. 12) of separate floating gripper holder 522, and locked in it by any known locking means. Each gripper mount 522 is suspended by means of a spring suspending system (not shown) placed under cover 530. The spring suspension system keeps gripper holder 522 floating with respect to removable gripper carrier body 532.

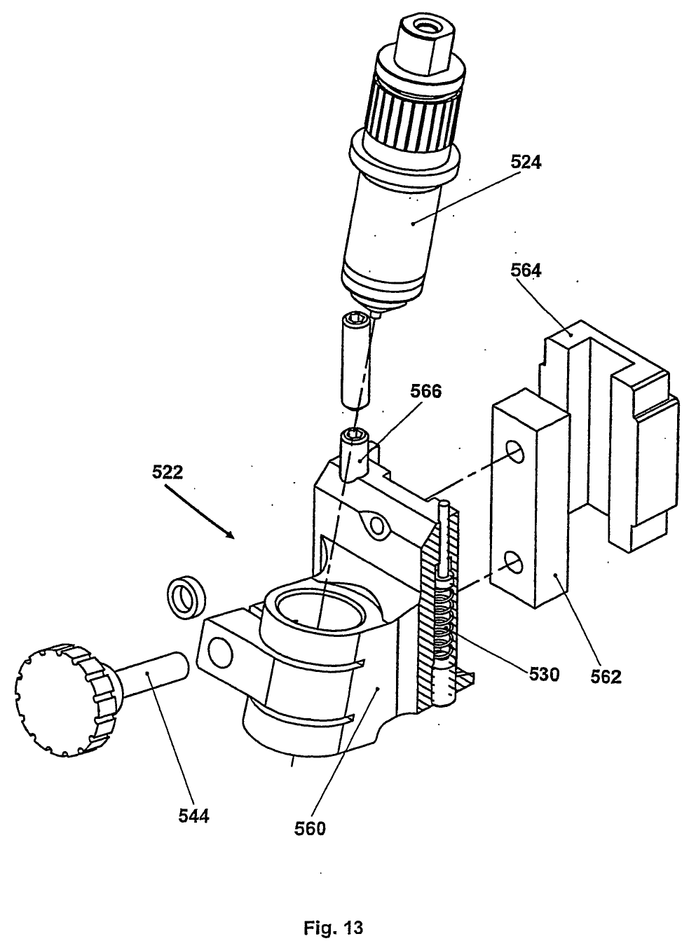

FIG. 13 shows, in detail, the structure and principles of operation of floating gripper holder 522. Gripper holder 522 includes gripper holder body 560, which slides on gripper holder guide 562. Guide 562 is fixedly attached to gripper holder mount 564, which is attached with the help of screws (not shown) to body 532 of second exemplary removable gripper carrier 520. Bushing 566 sets the preload on spring suspension system 530. This preload defines the position of gripper holder body 560 and the point, when pressure applied to it, overcomes the preload forces and keeps gripper 524 inserted into it in a floating position. The value of preload force is set in a way that it does not exceed the force that may damage the work-piece to be polished. Under this arrangement, the maximal force acting on all work-pieces is equal, despite the protrusion of the gripper length. Lock screw 544 may optionally be locked by a torque key, and has a form suitable for this.

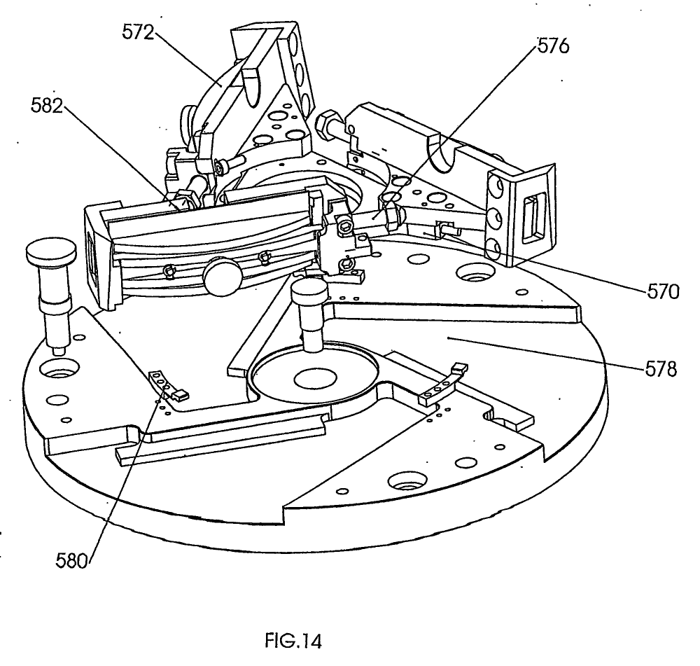

FIG. 14 is an illustration of a third exemplary removable gripper carrier constructed as a long work-piece removable gripper carrier 570, with grippers adapted for holding long and flat work-pieces 582. Such work-pieces may typically be planar light guide circuits, such as AWG's and variable optical attenuators (VOA's). Long and flat work-piece grippers 572 each hold a long work-piece. Grippers 572 sit in their nests/mounts 574. Adjustment screw 576 pushes long and flat work-pieces 582 to the opposite side of gripper 572 establishing desired work-piece lateral position. This action places all long and flat work-pieces 582 into identical position in each gripper 572. Long work-piece gripper carrier 570 mounts with the help of an interim flange 578 and bayonet locks 580 on rotating fixture 102 (see FIGS. 2 and 3).

Work-piece grippers are prepared per work-piece. FIGS. 15A, 15B and 15C show some exemplary work-piece grippers. FIG. 15A shows a gripper for cylindrical work-pieces 524. FIG. 15B shows a gripper 420 for rectangular or prismatic work-pieces and FIG. 15C shows a gripper 572 for long work-pieces. Grippers or chucks provide easy and correct holding of a work-piece through the whole process. A work-piece is held in the same chuck during setup, polishing, cleaning, rinsing, and inspection. It is important that the gripper be correctly designed. The gripper defines the position of the work-piece with respect to generalized removable gripper carrier 56 and the polishing disk. It should hold the work-piece firmly, despite the forces applied to it. On the other hand, the gripper itself should enable easy and fast mounting in any removable batch gripper carrier 56, 510, 520, 570 or similar.

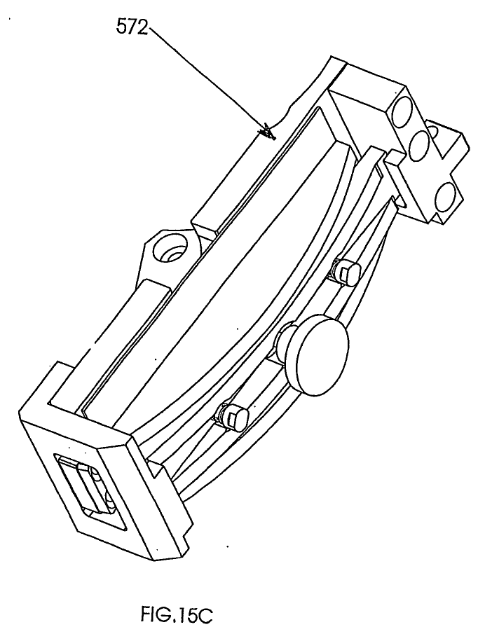

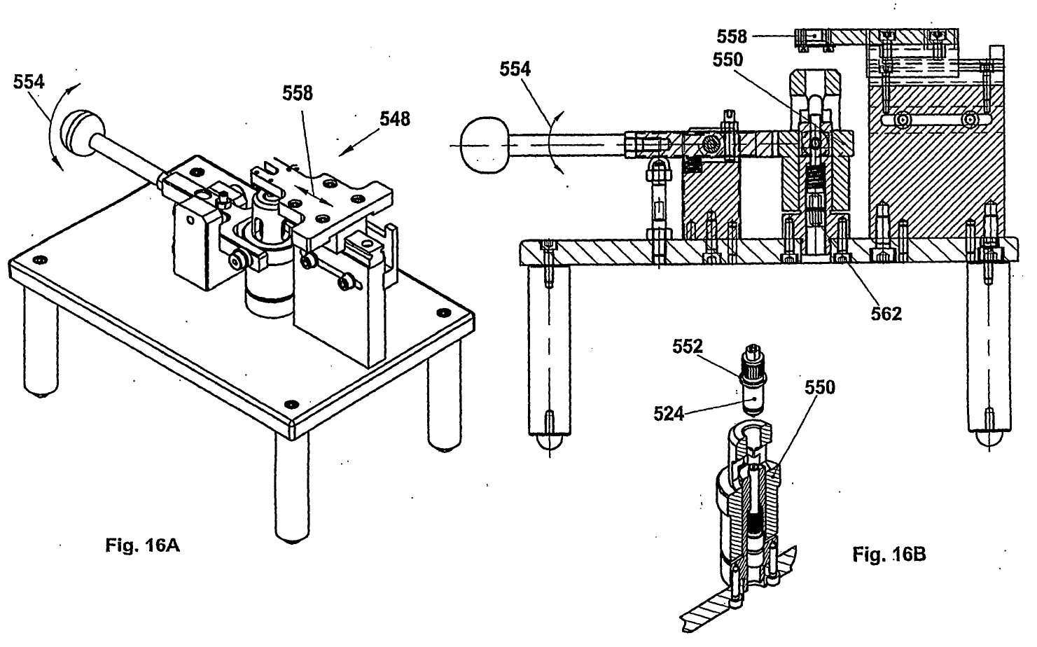

Polishing batch setup will be explained now using first exemplary removable griper carrier 510 (FIG. 9), which is loaded, for example, by grippers 524 (FIG. 15A) with work-pieces. A relatively large number of grippers are loaded into each removable gripper carrier. Loading of work-pieces into grippers is preferably easy, consistent and repeatable for all work-pieces comprising the batch. An auxiliary work-piece-into-gripper insertion device facilitates the gripper-work-piece coupling process. FIG. 16A is a perspective view of a work-piece-into-gripper insertion device 548, which is part of the preparation station of the polishing system of the present invention. FIG. 16B is a cross section of a work-piece-into-gripper insertion device 548.

For work-piece loading purposes gripper 524 slides into gripper guiding and holding cylinder 550 (FIG. 16B). When gripper 524 firmly rests on shoulder 552 sliding lock 558 slides and locks it in this position. Lever 554 rises by rotation around axis 584 and presses spring 556 opening chuck 586 (FIG. 15A) of gripper 524. A cylindrical work-piece, for example, an optical fiber, a ferrule or others may be now inserted into gripper 524. Stopper surface 562 regulates the length of work-piece inserted. Following insertion, a conventional diamond-cleaving blade 564 cleaves the fiber.

FIG. 17A is a three dimensional representation of portable latching turret assembly 60 of polishing system 36 and preparation station 40 (FIG. 1) of the present invention. Prior to loading with grippers, removable gripper carrier is coupled with a unit allowing its rigid or floating position on the polishing surface. This assembly is termed portable latching turret assembly 60. Loaded with grippers, first exemplary removable gripper carrier 510 remains part of portable latching turret assembly 60 through the whole process, beginning with preparation station 40 and ending at inspection unit 72 (FIG. 21) of polishing station 38. (Partially loaded with grippers, portable latching turret assembly 60 may also be used for polishing purposes).

Portable latching turret assembly 60 is shown with a carry handle 242, and first exemplary removable gripper carrier 510 loaded with particular exemplary fiber optics grippers 524. Any excessive length of the fiber optics bundles is located during the preparation and polishing process on a semicircular hanger 248. Semicircular hanger 248 has protruding endings 240 that prevent slippage of the fiber optics bundles in the course of the process. Portable latching turret assembly 60 may be loaded with work-pieces at preparation station 40, and it remains in this condition through the whole process. Portable latching turret assembly 60 may be assembled easily and quickly in its working or loading position by means of a bayonet-type lock 250. Use of a number of identical removable work-piece grippers streamlines batch processing of large quantities of work-pieces.

FIG. 17B is a three dimensional representation of portable latching turret assembly 60, with a second exemplary removable gripper carrier 520 with floating gripper holder 522, loaded by grippers 524 with work-pieces. Thus loaded portable latching turret assembly 60, when work-pieces touch the polishing disk surface, each gripper mount 522 floats or contracts the spring by an amount equal to the protruding length of work-piece. For example, when fibers with connector ferrules are polished, fibers may protrude by differing lengths. The first touch, and subsequent polishing, may apply excessive pressure only on one or two fibers. Forces generated at this touch may cause irreversible damage to fibers protruding longer than other fibers. Second exemplary removable gripper carrier 520 of the present invention eliminates the application of excessive pressure to one or a few such protruding work-pieces. This damage is avoided by setting the value of preload force of gripper 524 in a way that it does not exceed the force that may damage the work-piece. Under this arrangement, the maximal force acting on all work-pieces is equal, despite their length.

FIG. 17C shows portable latching turret assembly 60, with long work-pieces removable gripper carrier 570 attached to it. Thus, application of a similar generalized removable gripper carrier 56 concept to different form and size work-pieces enables their processing on the same polishing system.

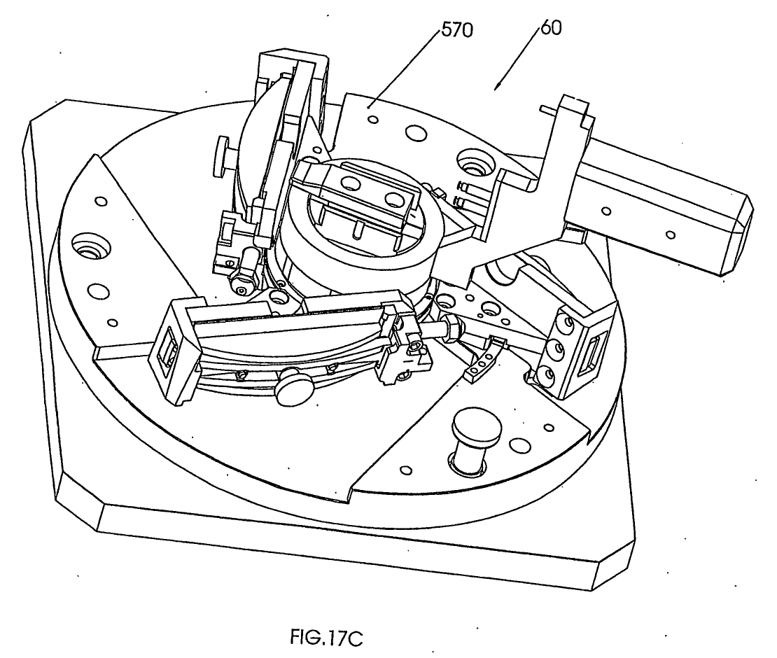

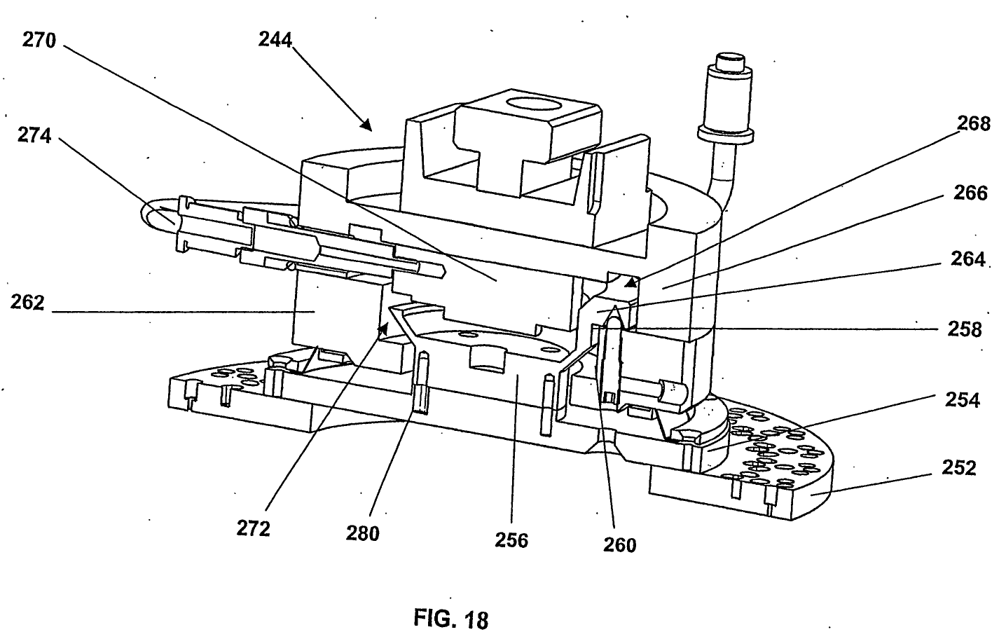

FIG. 18 is a schematic illustration of the construction of portable latching turret assembly of polishing system 38 of the present invention. A particular portable latching turret assembly 244 includes a flange 252 to which a generalized removable gripper carrier 56 (not shown) with a batch of work-pieces may be easily and quickly attached. Flange 252 serves as an adaptor for different removable gripper carriers 56, 510, 520 or 570, and it is attached by means of an interim flange 254 to a sliding cylindrical bushing 256. Cylindrical bushing 256 has a cylindrical part 258 and a shoulder 264. Sufficient clearance allows easy sliding between cylindrical part 258 and counter bore 260 of a bottom flange 262, as well as allowing some angular freedom in the drawing plane and in the direction perpendicular to the drawing plane. Top flange 266, having an inner hollow depression 268 with its inner diameter slightly larger than the diameter of shoulder 264 of cylindrical bushing 256, covers bushing 256 and bottom flange 262. An inflatable rubber piston 270 is inserted into space 272 created between flanges 266 and the inner recess of sliding cylindrical bushing 256.

Portable latching turret assemblies 60 and particular portable latching turret assembly 244 differ by the type of removable gripper carrier 56, 510, 520 or 570, but all may operate in rigid and floating modes of operation. (Only one numeral 244 will be used in the subsequent text, although the description is valid for all portable latching turret assemblies.) The rigid, and floating modes of operation of portable latching turret assemblies 60 will be explained in the polishing system section. It should be noted, however, that the first rough polishing step made on preparation station 40 , except in the cases where floating gripper holder 522 is used, is always performed in rigid mode.

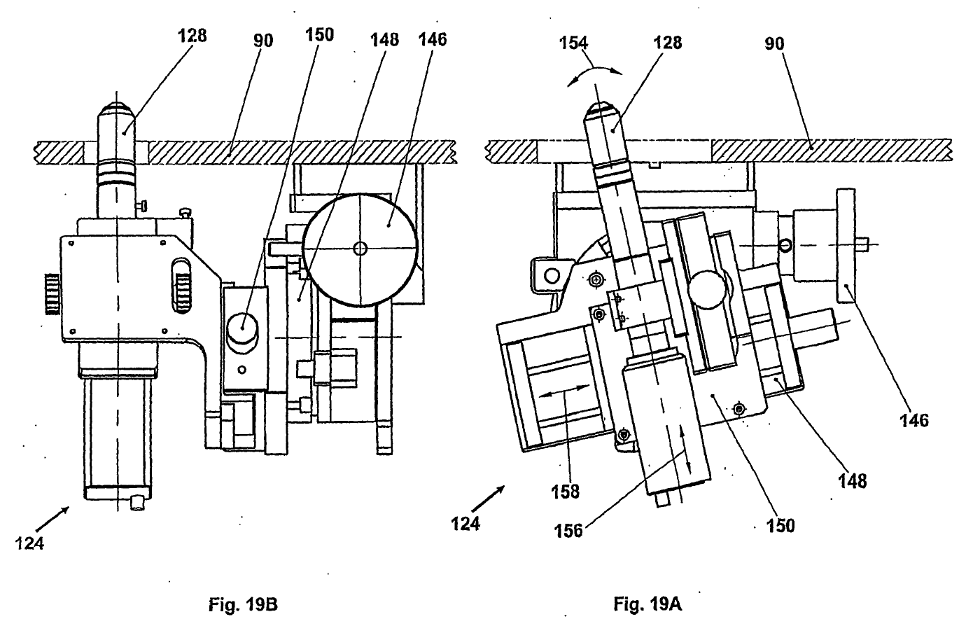

FIGS. 19A and 19B are front and side views of the inspection and measurement unit of preparation station 40 (FIGS. 1, 2, and 3). Inspection unit 124 may include a number of microscopes, or a single microscope 128 with variable magnification and with different types of illumination. Microscope 128 is used to inspect the rough polished surface of a work-piece and set it in the proper orientation. Microscope 128 is coupled to a video camera (not shown) that displays the images on screen of monitor 112. Displayed images may be captured and stored for archival purposes or subsequent use. In addition to polished a work-piece image, calibrated fixed and movable grid lines may be displayed on screen of monitor 112. Fixed gridlines may be calibrated in different measurement units. Calibrated in measurement units gridlines provide convenient tools for different measurements and work-piece spatial orientations.

Microscope 128 has angular freedom of movement 154 and bi-axial linear freedoms of movement, as indicated by arrows 156 and 158. A handle 146 activates an accurate rotation mechanism that sets the angular position of microscope 128. Microscope rotation establishes it in a position matching the polishing angle of a work-piece under inspection, and enables the focusing of microscope 128 in the polishing plane. Motor driven stages 148 and 150 allow accurate positioning of microscope 128 over the inspected area, as well as focusing microscope 128 on the work-piece inspected.

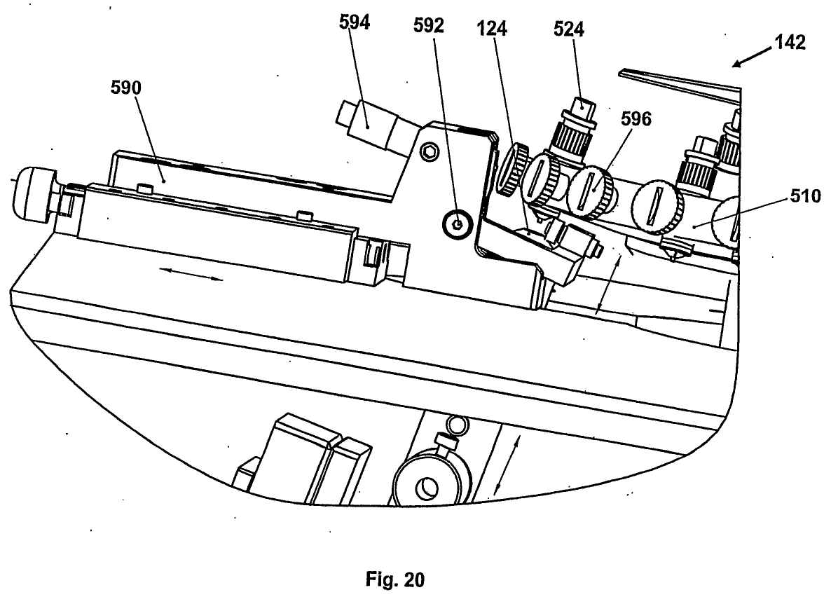

FIG. 20 (see FIGS. 1, 2, and 3) illustrates micrometric gripper height adjustment mechanism 142 of preparation station 40. Micrometric gripper height adjustment mechanism 142 assists operator of preparation station 40 in bringing all rough polished surfaces of work-pieces mounted on the same portable latching turret assembly into one common polishing plane.

Micrometric gripper adjustment mechanism 142 includes a lever 590 rotating on axis 592. One end of lever 590 is below removable gripper carrier and it is capable of moving up and down gripper 524 or any other gripper holding a work-piece. Rotation of micrometric screw 594 alters position of lever 590 and associated with it at a particular removable gripper carrier position, gripper 524. A change in position of lever 590 moves gripper 524 up or down, bringing it in or out of focus of inspection system 128. This movement enables placing all work-piece polished surfaces into identical position in the same plane. Prior to altering the position of lever 590, the lock thumbscrew 596 should be released.

Polishing, Cleaning and Inspection Station

FIGS. 21, 22 and 23 are illustrations of the top view, front view and rear view of polishing, cleaning and inspection station 38, which is a part of the high throughput, high precision automated polishing system of the present invention. The polishing station, an illustration of the top view of which is shown in FIG. 21, may include a main frame 50, a the top plate 100, on of which a number of polishing units 52 may be mounted, with their drives and direct drive controls. A number of cleaning units 54 for cleaning processed batches of work pieces may also be positioned on the top part of main frame 50. One or more of cleaning units 54 may serve as a rinsing and drying unit. For exemplary purposes a double circle marks a designated rinsing and drying unit 55, although generally any one of cleaning units 54 may be converted into a rinsing and drying unit. Alternatively, additional contact cleaning units (not shown) may be mounted on the top part of main frame 50.

Polishing units 52 and cleaning units 54, including contact cleaning and rinsing and drying units 55, have similar external dimensions, and are interchangeable as required by a particular process. For example, there may be a configuration with three polishing and three cleaning units or a configuration with four polishing units and two cleaning units. Other combinations as required by a particular work-piece process may be supported.

Stages may be assembled on the top plate 100 of main frame 50, as shown in FIG. 21, on which a rigid mount 58 holding a portable latching turret assembly 60 with a generalized removable gripper carrier 56 and a batch of work-pieces 62 (see FIG. 22) is positioned. The stages allow rigid mount 58 to be moved in X-direction 64, Y-direction 66 and Z-direction 68 (see FIG. 22). Rigid mount 58 can move practically to any point located on top part 100 of polishing station 38. Moving rigid mount 58, serving in this case as a built-in robotic arm, with latching turret assembly 60, and batch of work-pieces 62 (see FIG. 22) delivers it to any processing station located on top surface 100 of main frame 50. An inspection unit 72 for inspecting processed work pieces may be positioned in a recess of the top plate 100 of main frame 50.

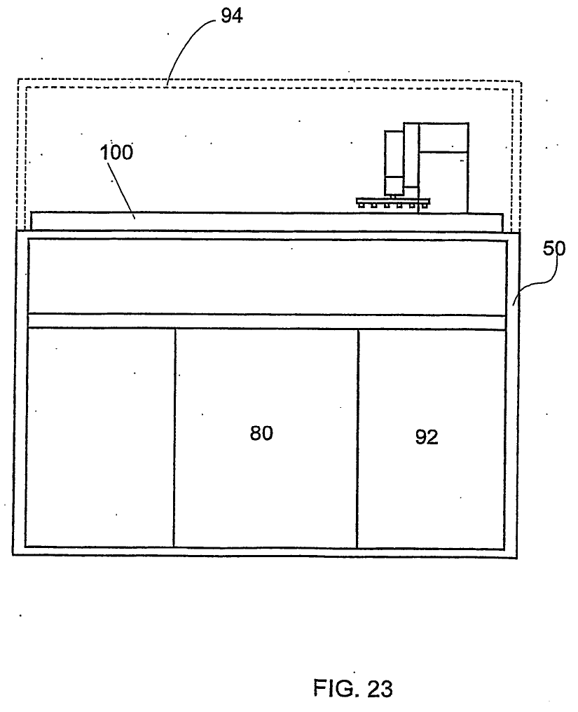

A cleaning fluid dispensing, collection, and a processing unit 74 is shown in FIG. 22, wherein a control computer 42, and an air pressure and vacuum delivery unit 78 may be incorporated into main frame 50. A power distribution unit 80, as shown in FIG. 23, may also be placed within main frame 50. A cover 94, shown in phantom lines in FIG. 23, may envelop the top part of the polishing station. Cover 94 limits the entrance of ambient air into the processing compartment of work-piece 62, allowing creation of relatively clean and dust free air flow under cover 94. A pair of cables 84 and 86 (see FIG. 22) connecting control computer 42, respectively, to operator's stand 44 (shown only in FIG. 1) with a monitor and GUI, and preparation station 40 (FIGS. 1, 2 and 3). Alternatively it may be connected by means of communication and interconnection unit 92.

Computer 42 may control all inspection processes, perform statistical process analysis, keep process and parts databases, and issue different reports. Control computer, 42 may also contain programs enabling process learning capabilities. These learning capabilities support continuous polishing process improvement. They may identify process degradation parameters and indicate reasons causing the process degradation.

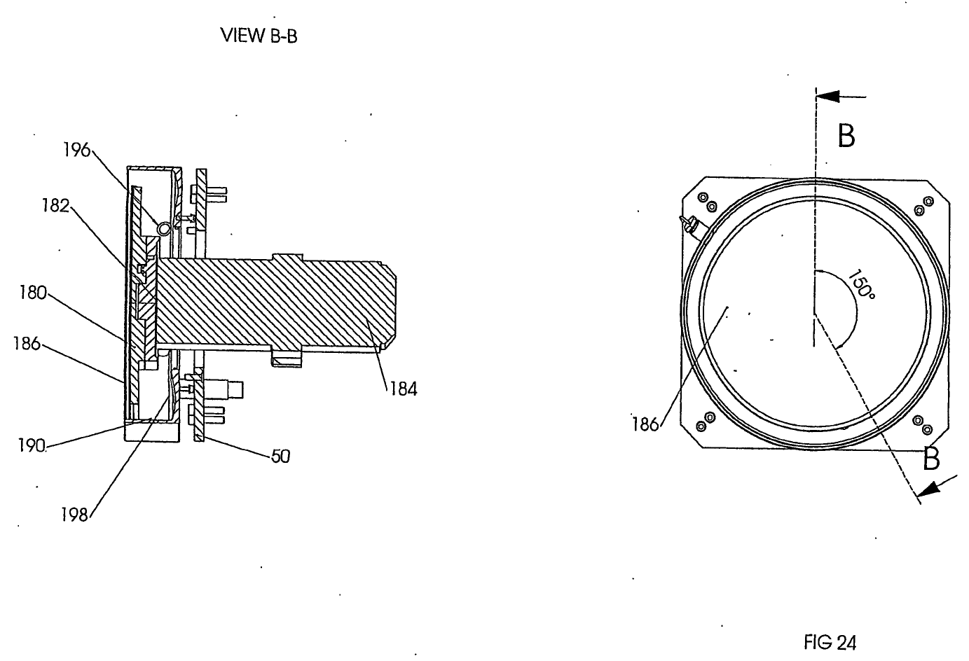

Some of the units comprising polishing, cleaning and inspection station will be explained now. FIG. 24 is a schematic illustration of polishing unit 52 of polishing station 38 with section B-B detailing the polishing disk surface. Polishing unit 52 includes a polishing disk 180 on which different grits of polishing paper may be placed. Alternatively, substrates accepting different meshes of slurries may be placed on it. Cloth and other materials useful in contact cleaning of processed work-pieces may be placed on polishing disk 180. Polishing disk 180 is connected by means of a coupling 182 to axis of a DC brushless electric motor 184. Coupling 182 allows easy replacement of disk 180 enabling off-line polishing paper or other materials that may be mounted on the disk changes or polishing surface renewal without affecting the work of polishing station 38. The outer surface 186 of disk 180 is lapped to yield high surface flatness. A waterproof gasket 188 seals the motor-disk assembly to a stainless steel basin 190 and to main frame 50. A fluid dispenser (not shown) delivers cooling fluid or polishing slurry into basin 190. A fluid level sensor 196 mounted in basin 190 prevents flooding by the polishing slurry or cooling fluid. Normal fluid level is indicated by numeral 198. The rotational speed of the polishers can be adjusted in a wide range of 10-300 rpm, enabling an optimal polishing speed and material removal rate. Rotation of polishing disk 180 in both clockwise and counter clockwise directions is supported. Speed changes are performed in response to control computer 42, which controls DC brushless electric motor 184.

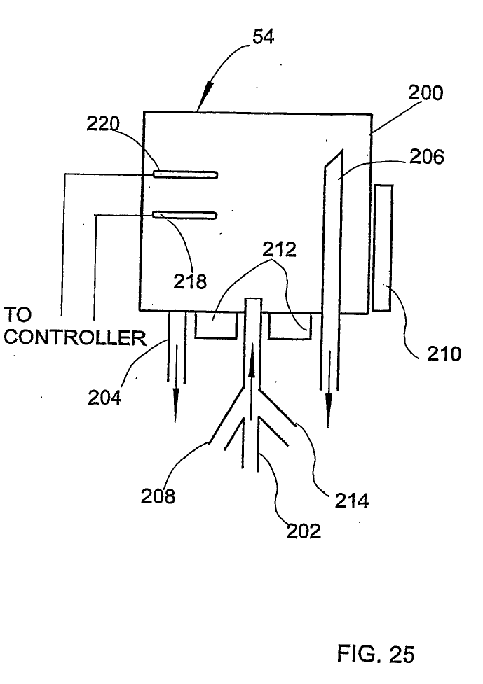

FIG. 25 is a schematic illustration showing a side view and a bottom view of cleaning unit 54 of polishing station 38 of the present invention. Cleaning unit 54 is included in polishing station 38 in order to prevent cross contamination of work-pieces 62 between each of the polishing steps, and to obtain the required degree of cleanliness for subsequent image inspection and image analysis. Cleaning unit 54 includes a stainless steel basin 200 with fluid inlet tubing 202, fluid drainage tubing 204 and fluid overflow tubing 206. Fluid inlet tubing 202 may further combine a number of tubes for conducting de-ionized water, as well as various cleaning solutions, detergents, alcohol and other fluids. A heater 210 heats up cleaning fluid in basin 200 of cleaning unit to a temperature enabling optimal cleaning results. Two ultrasonic agitators 212 continuously agitate cleaning fluid.

Cleaning unit 54 is further equipped with two fluid level sensors. A fluid level sensor 218 may sense minimal cleaning fluid level. It is connected to control computer 42, and activates a fluid pump (not shown), which is incorporated in cleaning fluid dispensing, collection and processing module 74 that replenishes the cleaning fluid in cleaning unit basin 200 until a level is reached, as defined by proper cleaning conditions, and controlled by optimal fluid level sensor 220. Optimal fluid level sensor 220 may be also connected to control computer 42, and switches-off a fluid pump (not shown) located in cleaning fluid dispensing, collection and processing module 74, thereby preventing fluid overflow. Should the latest operation fail, excessive fluid may be drained via overflow drainage tube 206. At the end of the day, or on any other power-off event, cleaning fluid is automatically drained from basin 200.

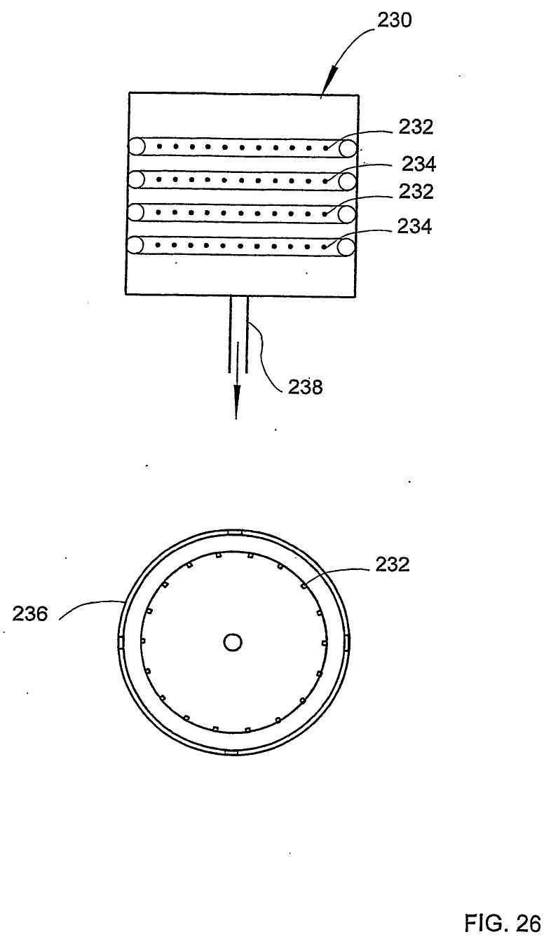

FIG. 26 is a schematic illustration of one of the embodiments of a rinsing and drying unit 230 of polishing station 36 of the present invention. Rinsing and drying unit 230 utilizes jets of clean water, or cleaning solution, and preheated filtered, dry air for final cleaning of a processed batch. It has two alternating series of air-dispensing nozzles 232 and fluid-dispensing nozzles 234, equally spaced and distributed around the circumference of basin 236. This unique design ensures uniform coverage of portable latching turret assembly 60 and, in particular, generalized removable gripper carrier 56, which holds a batch of work-pieces 62, each with a polished area. The intensity of each of the jets can be individually adjusted. Used rinsing fluid is evacuated through an opening 238 at the bottom of basin 236. A suction unit (not shown) located at the base of basin 236 increases the efficiency of the drying process and prevents undesired particles from reaching critical sections of the system. Air introduced through nozzles 232 is typically at an elevated temperature. Control computer 42 (FIG. 1), through air pressure and vacuum delivery module 78 FIG. 22), controls both airflow and a vacuum pump. In order to ensure identical rinsing and drying conditions for all work-pieces 62, the Z-stage, which holds portable latching turret assembly 60 with batch of work-pieces 62 oscillates in the vertical direction. A cleaning recipe defines the duration of the rinsing and drying process.

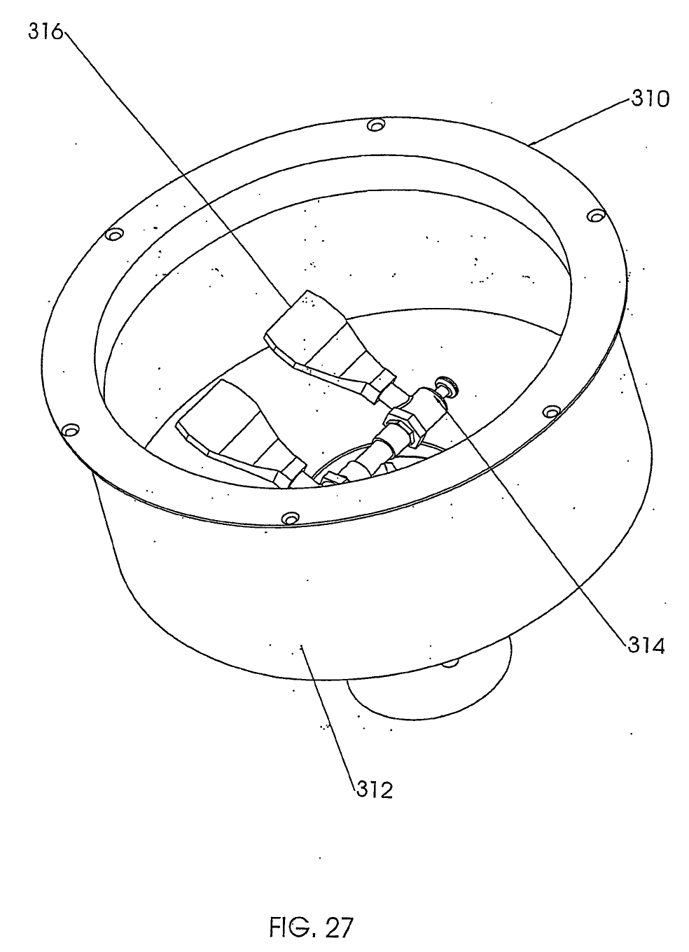

FIG. 27 is a three dimensional schematic illustration of an alternate embodiment of a rinsing and drying unit 310 of polishing station 38 of the present invention. Rinsing and drying unit 310 includes a stainless steel basin 312 with a rotating rinsing fluid and dry air dispensing mechanism 314. Rotating rinsing fluid and dry air dispensing mechanism 314 of rinsing and drying unit 310 utilizes jets of clean water, or cleaning solution, and preheated filtered, dry air for final cleaning of a processed work-pieces batch. It has a series of fluid-dispensing nozzles 316, which are part of rotating fluid dispensing mechanism 314. Rotation of fluid dispensing mechanism 314 provides a uniform spread of cleaning fluid over work-pieces, grippers and any removable gripper carrier 56, 510, 520 or 570 (not shown). A cleaning recipe defines the duration of the rinsing and drying process. At the end of a fluid flashing process, control computer 42 switches off the delivery of cleaning solution, and hot air is dispensed through same nozzles 316. In all other aspects, rinsing and drying unit 310 is similar in operation to rinsing and drying unit 230.

As indicated earlier, the external dimensions and electrical connections of polishing unit 190; cleaning unit 200; and rinsing and drying units 230 and 310, are made identical and thereby support their relative position interchangeably. Accordingly, different high throughput, high precision, integrated, automated micro-optical and photonics elements polishing system 36 configurations are thereby supported.

Typically, a number of portable latching turrets with identical generalized removable gripper carriers 56 are used for batch processing. Completely loaded with work-pieces 62 prepared for polishing, portable latching turrets are removed from preparation station 40 and positioned on polishing station 38. Robotic arm 46 may move portable latching turret assembly 60 from station to station. Alternatively, it may be hand carried from station to station maintaining the required spatial orientation of gripper carrier 56 with batch of wok pieces 62.

It was noted earlier that portable latching turret assemblies 60 may operate in rigid and floating modes of operation. When brought in contact with polishing disk surface 186, portable latching turret assembly 60 carrying generalized removable gripper carrier 56 with individual work-piece holders for example 524 (FIG. 17A) are in floating position. Generalized removable gripper carrier 56 placement on polishing disk surface 186 in floating position matches the polished surfaces plane created by the intersection of previous polishing disk with polishing disk surface 186. This placement method saves polishing time and improves material removal rate, since no new polishing angle is created. If the above mentioned polishing planes are not matched, excessive material removal may occur on some of the parts, and work-piece 62 damage and spoilage increases.

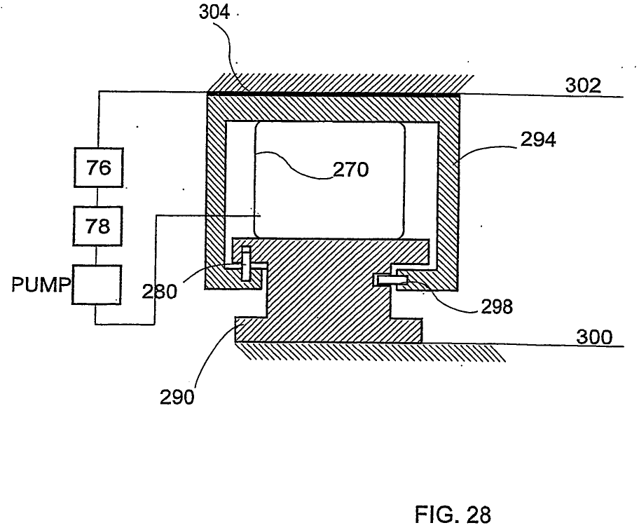

Polishing is typically performed with a certain amount of force. The force exerted on the polishing pair should preferably be carefully controlled. Control of the descent speed of the latching turret assembly, with a batch of work pieces, controls the polishing removal rate. Polishing force control and a monitoring mechanism prevents excessive polishing force. FIG. 28 is an illustration of the polishing force control and monitoring mechanism. In floating mode of operation the assembly of flanges 252 and 254 moves with respect to bushing 258 on three guides 280 (FIG. 18). Guides 280 provide freedom of linear movement in the Z-direction and provide clearance between bushing 256, resting on rubber piston 270. Counter bore 260 provides freedom of angular movement around X and Y-axes. Rubber piston 270 may be inflated with the help of air passage 274. Bushing 256 has two guides (not shown), placed diametrically opposite each other, to prevent it from rotating.

In rigid mode of operation rubber piston 270 may be inflated with the help of air passage 274 to a level where it exerts pressure on bushing 256 to a position wherein it rests with its shoulder 264 on bottom flange 262. Pressure developed by air in rubber piston 270 prevents any movement in the Z-direction. Rotational movement is prevented by friction between shoulder 264 of bushing 256 pressed to bottom flange 262 by pressure of rubber piston 270.

Part 290 schematically designates assembly comprising a number of elements of lower part of portable latching turret assembly 60 including removable gripper carrier 56. Part 294 schematically designates upper part of portable latching turret assembly 60 including bayonet-type lock 250 (see FIG. 17A). Numeral 280 designates guides on which assembly 290 may slide in the Z-direction and numeral 298 designates pins preventing undesired rotational freedom of assembly 290. Numeral 270 marks an inflatable rubber piston. Line 300 indicates the polishing plane and line 302 indicates a rigid reference plane along the Z-direction stage to which portable latching turret assembly 60 is attached by means of bayonet-type lock 250. A strain gage 304 is placed at the rigid reference plane 302 along the Z-direction stage (see FIG. 22).

Z-direction stage movement brings polishing disk surface 186 (see FIG. 24) into contact with particular portable latching turret assembly 240 carrying generalized removable gripper carrier 56 with individual work-piece holders 246. The contact plane is also the polishing plane and it is marked by numeral 300. Strain gage 304 senses the first touch or contact between work-pieces and polishing disk surface 186. Continuous advancement or descent of Z-direction stages at a predefined speed, which matches the target material removal rate, is performed under the gravity force of portable latching turret assembly 60, and small additional force enabling target descent speed. The value of a predefined descent speed depends on the type of work-piece being processed, the grit of the paper, number of previously polished batches and other parameters of the process. Such speed may be from 0.1 micron/sec to 10 micron/sec.

The descend speed of portable latching turret assembly 60 with generalized removable gripper carrier 56 and batch of work-pieces 62 in the Z-direction, as indicated by arrow 68 (see FIG. 22) stages on removable gripper carrier 56 during the polishing process, is constantly monitored by control computer 42. Control computer 42 compares the actual descend speed with the desired target descend speed, and in cases of a large deviation of the target descend speed, control computer 42 may change the polishing speed for a particular batch of work-pieces being processed. In cases where the force should be changed, a command is issued by control computer 42 changing the polishing force and accordingly the descend speed in the Z-direction.

Large polishing forces may damage work-pieces being processed. In order to avoid undesired and large polishing forces that may be required to maintain constant descend speed, the force exerted by continuous advances in the Z-direction stages on generalized removable gripper carrier 56 and batch of work-pieces 62 during the polishing process is constantly monitored by strain gage 304. The force control system operates in a closed loop based on feedback provided by strain gage 304 and may, for example, limit the force applied in floating mode of operation. Precise control of the forces applied is ensured by proper selection of the sensitivity and operating range of strain gage 304.

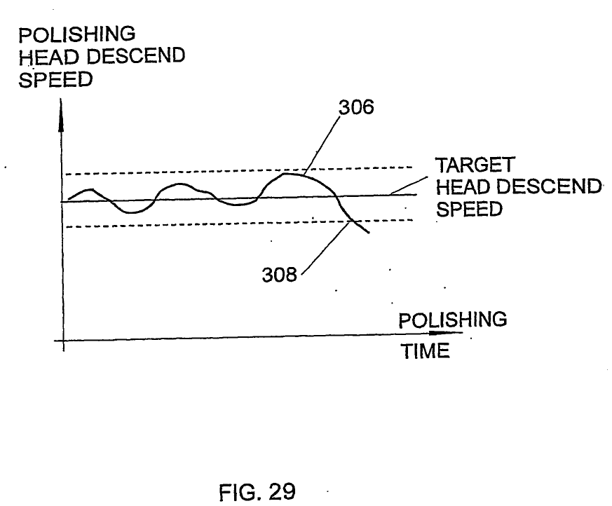

Maintaining and monitoring constant descend speed is especially important when large batches of similar work-pieces 62 are processed. Changes in descend speed provide valuable information on the status of polishing material and fluids. For example, if at constant polishing force the descend speed changes in a range larger than a predefined range, it may indicate the polishing paper has become clogged, and hence the material removal rate is decreasing. By setting the proper descend speed decrease threshold, or tolerance, it is possible to inform the operator of the need to change polishing paper. Polishing paper change interrupts continuity of the polishing process and reduces machine throughput. The message may be automatically issued by control computer 42 and displayed on operator stand monitor 44. Maintaining polishing process parameters ensures repeatable polishing results. FIG. 29 is a schematic representation of the paper change indication point using descend speed variation. The actual descend speed variation is indicated by numeral 306, dotted lines indicate the descend speed variation threshold and point 308 indicates paper change point.

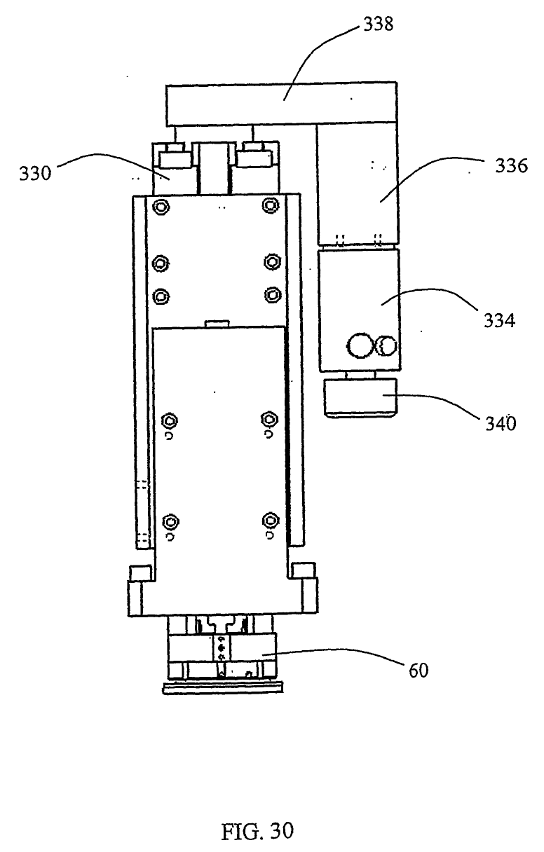

FIG. 30 is an illustration of Z-direction stage construction. Z-direction stage 68 includes a set of parallel guides 330, on which portable latching turret assembly 60 slides. Movement of portable latching turret assembly 60 is accomplished by a precision screw, and is monitored by a linear encoder (not shown). A motor 334 through a gear 336 and flexible transmission combination 338 drives the screw. A separate rotary encoder 340 provides information on motor position. Use of two encoders eliminates potential position errors that may be introduced by flexible transmission 338.

FIG. 31 is a schematic representation of a computer generated orbital movement pattern. Polishing disk 180 rotates with a constant speed in the direction indicated by arrow 450. Portable latching turret assembly 60, with removable gripper carrier 56, is mounted on Z-direction stage 68 (not shown in FIG. 31), and respectively on X-direction 64 stage and Y-direction 66 stage. Digital control means, driving X-direction 64 and Y-direction 66 stage motors, with suitable signals, may achieve orbital movements of Z-direction stage 68, holding portable latching turret assembly 60 with removable gripper carrier 56. For example, driving both stages with an equal frequency and an amplitude signal of the form Kxsin(ω+πt) will result in a circular orbital movement shown by dotted line 452. By changing the amplitude of one of the signals, the result is an elliptical orbital movement as shown by dotted line 454. Other orbital movement patterns, such as the figure 8 (eight)—type shown by line 456, and others, may be achieved by changing the drive signals form, frequency and amplitude.

Digitally generated and controlled orbital movement provides a number of options and benefits that conventional mechanical systems do not support. Change of orbital pattern movement is one option. In addition to this, variable speed within the same orbital movement pattern is possible. The flexibility of movement patterns, combined with better speed control, provide higher polished surface quality. Control computer 42 (FIGS. 1 and 21) sets and controls parameters of orbital movement in accordance with the work-pieces processed.

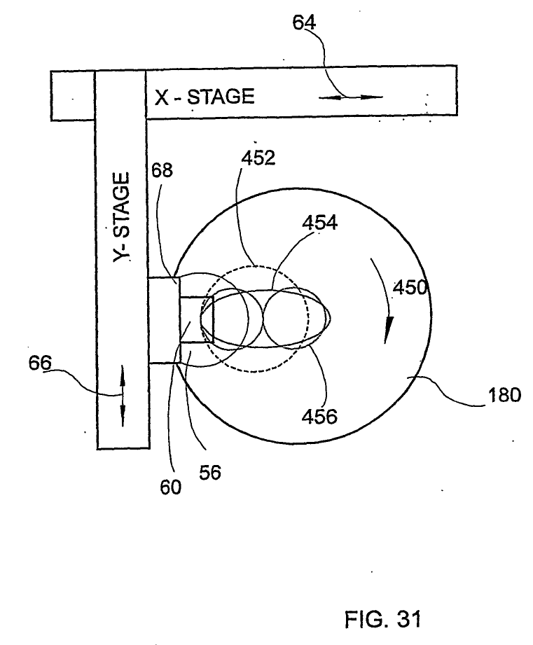

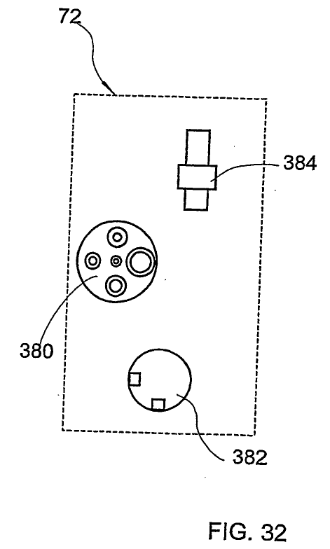

Digital control of the speed of orbital movement pattern enables better polishing speed control, and equalizes the polishing speed of different parts of work-piece 62. as well as a batch of work-pieces 62.as shown in FIG. 32. The capability of positioning a batch of work-pieces 62 on practically any area of polishing disk 180 is enabled by X-Y stages movement.

FIG. 32 is a schematic illustration of inspection unit 72 of polishing station 38 of the present invention. Inspection unit 72 has been designed to measure angular and linear dimensions, inspect the polished surface of any work piece or cleaved ends of fiber optic cable, and assess surface quality. The setup of inspection unit 72 is automatic in accordance with an inspection recipe. Inspection unit 72 includes three optional sub-units: optical microscope sub-unit 380; polished angle measurement unit 382; and interferometer based surface quality assessment sub-unit 384.

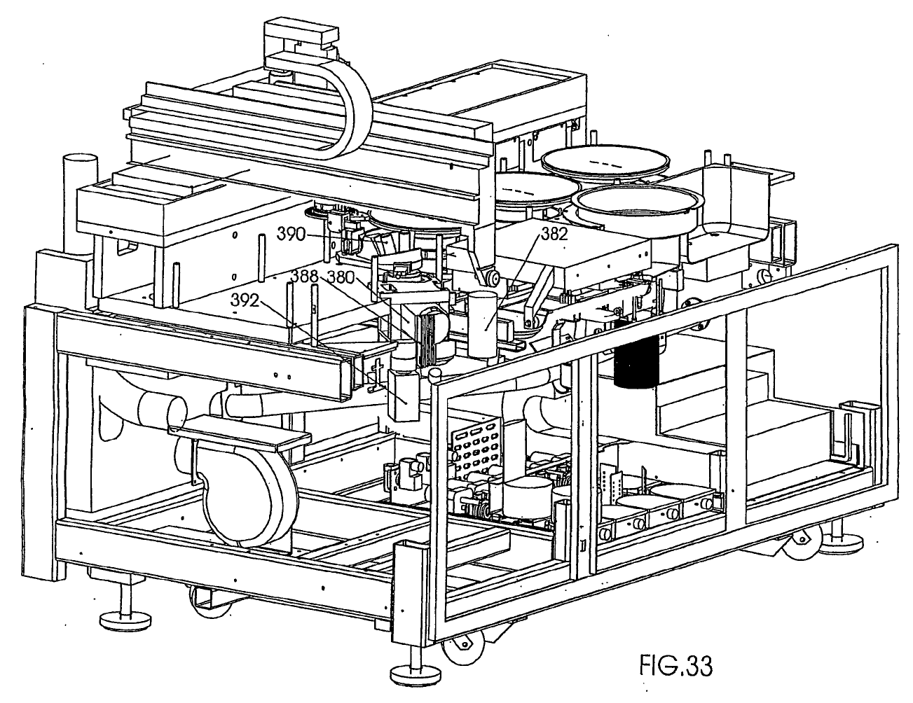

FIG. 33 is a cut through view of polishing station showing integrated inspection unit 72. An optical microscope sub-unit 380 has bright and dark field, auto illumination capability, provided by light source 388. The power of the illumination may be regulated and set at desired values, enhancing the range of image processing options. A large range of objectives 390, provides a range of magnifications matching the inspection needs of a particular work-piece. A turret, having holding range of microscope objectives 390, is motorized and computer controlled, enabling easy magnification changes. A differential interference contrast (DIC) microscope (not shown) may also be part of optical inspection sub-unit 380. Optical inspection sub-unit 380 is coupled to a color CCD camera 392 for video image capture and processing.

The working magnification of optical inspection sub-unit 380 is a function of optical sub-unit magnification and electronic sub-unit magnification. The initial inspection system magnification is selected in a way that preferably enables viewing of a complete work-piece, if work-piece size allows this. Maximum magnification should preferably enable sub-micron defect detection. For example, linear dimensions inspected at one magnification may be 2000×1600 microns and respectively 500×400 microns for a magnification four times larger than the previous one. Variable magnification allows inspection of different size work-pieces and different areas of the same work piece at optimal conditions.

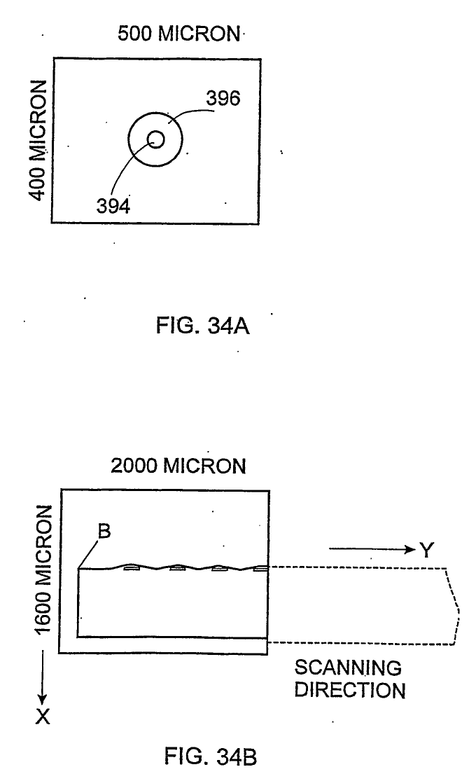

FIG. 34A is an illustration of an exemplary calibrated image of polished fiber tip/end with diameter of 125 micron. Numeral 394 marks core and numeral 396 indicates clad. FIG. 34B is an illustration of another exemplary calibrated image provided by inspection unit of the polishing station of the present invention, showing a part of polished edge of a silicon arrayed wave guide grating work piece (AWG) with length of about 100 mm.

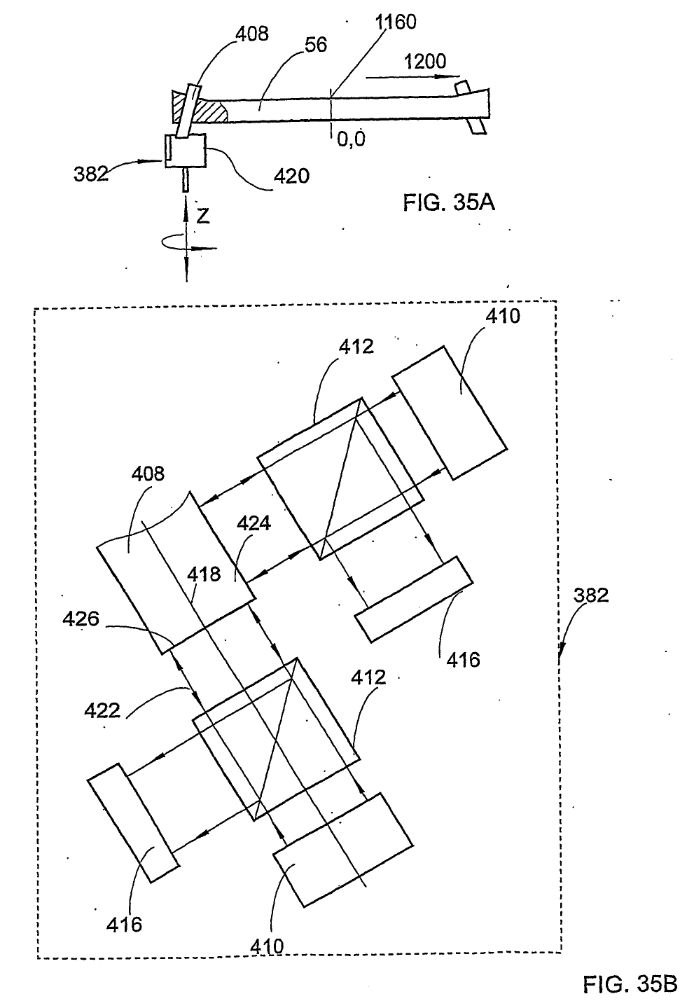

A polished angle measurement unit 382, shown schematically in FIG. 35A and FIG. 35B, is positioned on the top part 100 (FIG. 21) of polishing station 38, such that work-piece 408 is mounted in removable gripper carrier 56, and may be positioned over the rotation center of polished angle measurement unit 382. Polished angle measurement unit 382 (FIG. 35B), includes two collimated laser radiation sources 410, beam splitters/combiners 412 and laser beam position measuring detectors 416. All of the elements of polished angle measurement unit 382 are mounted on a rotating platform 420 (FIG. 35A) capable of moving in Z-direction also. The angle between the collimated laser beams is preset and well known. Insertion of a work-piece 408, with polished surfaces 424 and 426, causes changes in the position of collimated laser beams 422 on the surface of laser beam position measuring detectors 416. The deviation is proportional to the difference between the measured and the preset reference angle. The particular arrangement of angle measurement unit 382 and angle measurement method associated with it, allows measurement of the angle between the two optical surfaces of work-piece 408, automatically excluding work-piece mounting errors. The disclosed angle measurement method supports measurement of the angle of each optical surface forming work-piece 408. For example, detector 416 may detect the tilt or angle of surface 406 by rotation of work-piece 408 around its axis 418, which coincides with the optical axis of collimated laser beam 422. Distances between quadrant detector 416, beam splitter 412 and surface 426 of work-piece 408 define the angle measurement accuracy. By proper selection of these parameters, an accuracy of better than 0.05 degree may be achieved. For measurement of the angle of work-pieces having rotational symmetry such as ferrules or fibers, angle measurement unit 408 optionally may include only one angle measuring branch associated. Computer 42 (FIG. 1) collects and stores work-piece angle measurement data.

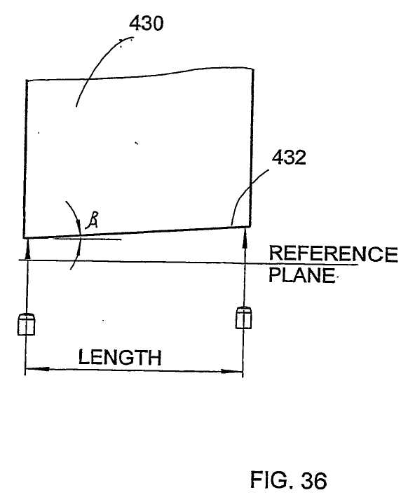

In an additional method of polished surface angle measurement shown in FIG. 36, the angle β (beta) of a long and narrow work-piece 430 is measured by refocusing on its surface microscope 380 (FIGS. 32 and 33). For greater accuracy, microscope 380 is preferably focused on the edges of long and narrow work-piece 430. Typically two focusing points are sufficient for surface profiling purposes. Refocusing is performed automatically either on discrete points of the surface or continuously scanning in accordance with focusing algorithm disclosed below. Concurrently, regular scanning means enable measurement of the length of facet 432 of long and narrow work-piece 430. The deviation in depth of field measured with respect to a reference plane allows simple and accurate polished surface angle measurement. Although the method for the simplicity of explanation was demonstrated on a long and narrow work-piece, it is equally applicable to any work-piece. The accuracy of the method depends on the distance between the focusing points.

Process Recipes and Databases

Polishing parameters for processing a batch of work-pieces 62 on the high throughput, high precision integrated, automated micro-optical and photonic elements of polishing system 36 (FIG. 1) may be set manually, based on operators experience, and may be set automatically by a computer, based on a batch identification code issued at preparation station 40 (see FIGS. 1, 2, and 3). Set up parameters, comprising part of the batch identification code may include type and geometry of work-piece 62 to be processed, work-piece 62 physical properties, number of work-pieces 62 on removable gripper carrier 56, work-piece geometric properties for inspection use, active area to be inspected, mechanical position of each work-piece 62 and others.

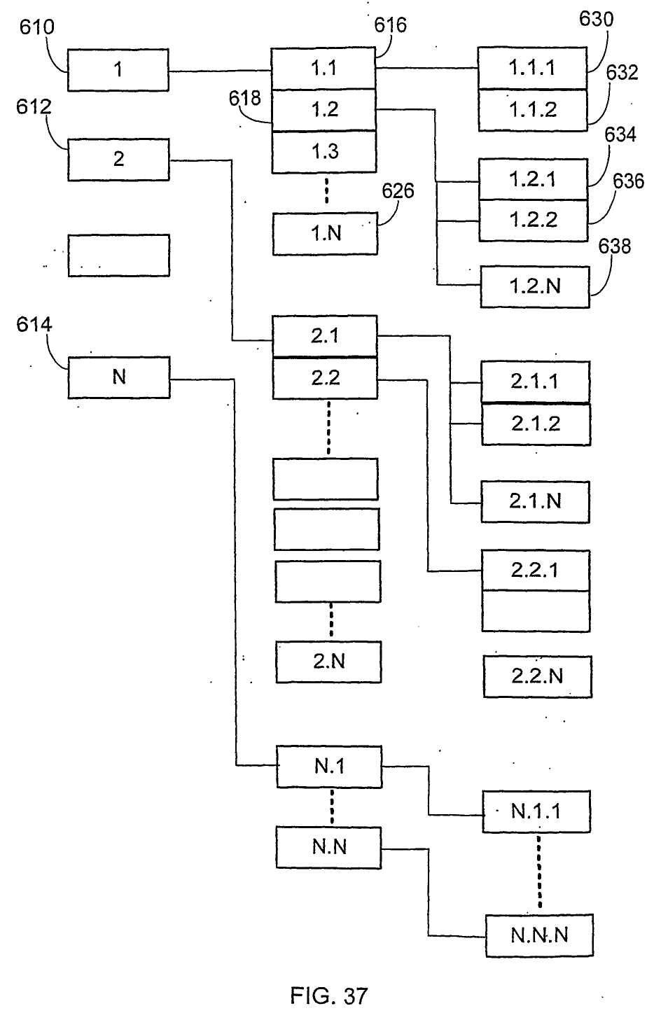

Based on set up parameters, high throughput, high precision integrated, automated micro-optics and photonic elements polishing system 36 (see FIG. 1) selects the appropriate polishing, cleaning and inspection process, also called the process recipe. Recipes defining all of the process parameters are stored in a recipe database. Recipe database structure and parameters are shown in FIG. 37.

The recipe database structure is a hierarchical one and includes a number of families 610, 612 and 614. Each family includes a number of micro-optical and photonic components 616, 618, 620, 622, 624 and 626 with similar properties. Typical samples of families may be AWG, a V-groove family, a connector family and so on. Components included in a family may be such as AWG1, AWG2, etc. Each component in the family may be characterized by a general component description, a component geometry type, processing liquid and others. A number of processing recipes 630, 632, 634, etc., may offer different processing parameters for each component.

The high throughput, high precision automated micro-optical and photonic elements polishing system 36 databases may also include tables, some of which may contain all of the system's parameters, and some of which may contain system accumulated data, such as log events, production reports and saved work-piece 62 images.

A recipe may include, but it is not limited to: polishing; cleaning; rinsing and drying; and inspection processes. A polishing process recipe may include such parameters as polisher number, type of Z-direction stage with latching turret assembly descent (floating or rigid), polishing time, and speed. A recipe may further include polishing direction and polishing force, continuous descent speed, amount of material to be removed, slurry number if slurry is used, use of water and lubricant, orbital movement frequency and amplitude and abrasive type selection.

A cleaning process recipe may include such parameters as the method of cleaning: contact or non-contact, cleaning station number, batch-cleaning time, ultrasonic agitation power, cleaning solution temperature, and others. A rinsing and drying process recipe may include such parameters as rinsing and drying time, rinsing solution temperature and others.

An inspection process recipe may include such parameters as particular device structure, definition of active area to be inspected and type of defects that should be checked in the inspection process. For each area and defect type threshold values may be set. Threshold values may be set for a single defect or for a group of defects containing maximal count of this defect in selected active areas. Defects may be classified by length or depth of a single defect, by area of a defect or perimeter of a single defect. Based on the threshold criteria set, the inspection result will amount to a “fail,” if for example the single defect length or sum length of all defects of this kind is more than the threshold value. The inspection result will amount to a fail, if the sum perimeter of all defects of this kind is more than the threshold value. Defects classification may take in account the roughness of surface on which the defects reside. Roughness is defined as a threshold value defining surface quality. High roughness value means low polished surface quality, low roughness value means high polished surface quality. Work-piece is considered spoiled and its inspection will result in a “failure” above certain roughness value.

Method of Set-up (Preparation), Polishing, Cleaning, and Inspection of a Batch of Work-pieces

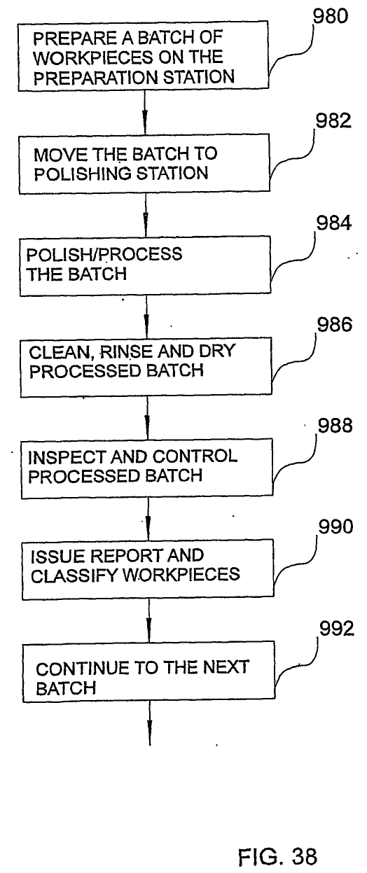

The method of preparation, polishing, cleaning, and inspecting work-pieces 62 using polishing system 36 (FIG. 1) of the present invention is as follows. FIG. 38 is a schematic high-level flowchart of the set up, polishing, cleaning, inspection and report generation processes. High throughput, high precision integrated, automated micro-optical and photonic elements polishing system 36 may be operable to polish a single work-piece 62 or a batch or work-pieces 62. Processing of batches of work-pieces 62 provides higher throughput than processing of single work-pieces 62. At step 980 a batch of work-pieces 62, which may be: fiber optics wave-guides; micro-optical elements, such as filters, plain glass plates, V-grooves, fiber optics connectors, AWGs, and others is assembled and properly oriented for the subsequent polishing process on the preparation station 40 (see FIGS. 1, 2, and 3). Following batch preparation completion, computer 42 issues a batch identification code and portable latching turret assembly 60 with removable gripper carrier 56 and work-pieces 62 is moved at step 982 from preparation station 40 to polishing station 38 (see FIGS. 1, 21, and 22). Manual or robotic means may accomplish the movement. A batch identification code is communicated to control computer 42 or entered manually by the operator via GUI facilities.

Polishing step 984 may take one or more polishing stages and employ different paper grits or slurries as required by particular batch identification code and processing recipe. In between the polishing stages the batch may be cleaned before moving to next polishing station, which will employ different grade paper or slurry. Upon completion of all polishing stages at step 986, the processed batch is cleaned, rinsed and dried. At step 988 it is positioned at the inspection module 72. Processed batch according to requirements is selectively measured for dimensional accuracy, polished angle values, surface quality and other parameters of interest. Alternatively, each work-piece may be measured and inspected. At step 990 a report qualifying and quantifying results of batch measurements is issued and at step 992 polishing station is ready to accept next batch.

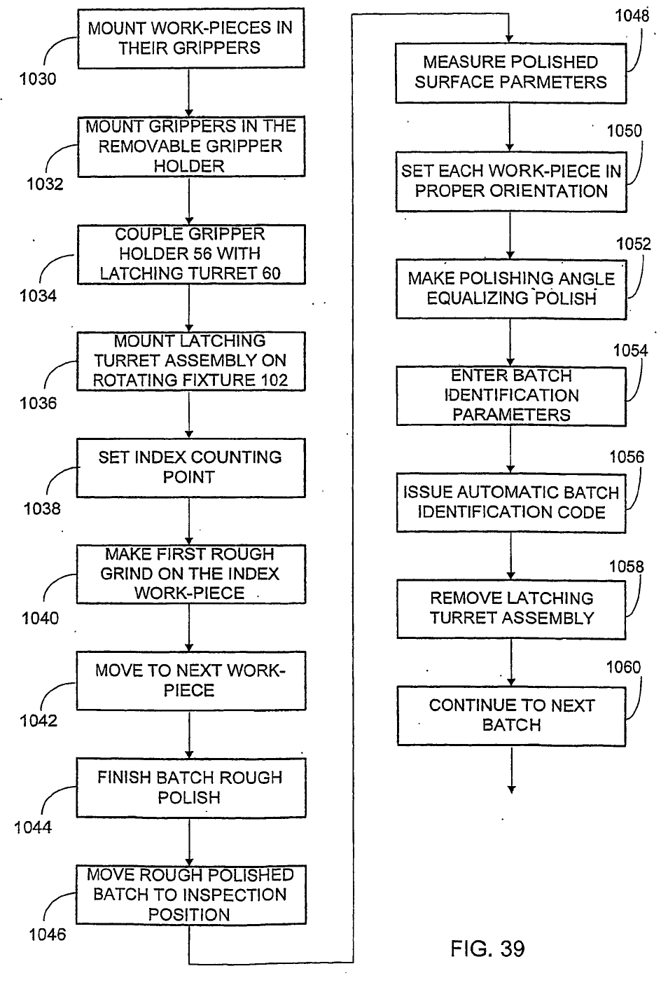

The method of setting up a batch of work-pieces 62 to be polished on polishing system 36 of the present invention using preparation station 40 is illustrated in FIG. 39, which is a high-level flow chart of processes performed on the preparation station.

At step 1030, each work-piece 62 is coupled with a proprietary chuck or gripper for example 524 (see FIGS. 11, 12, 13, and 15) as described earlier. Special work-piece insertion device shown in FIG. 18 facilitates coupling process.

Removable gripper carrier 56 (see FIGS. 2, 17A and 22) is coupled with latching turret 60 at step 1032. The assembly of removable gripper carrier and latching turret may now be moved to next process stage.

Grippers 524 with work-pieces 62 are inserted in their mounting holes 512 of first exemplary removable gripper carrier 510 (see FIG. 9) at step 1034. A removable gripper carrier 56 typically holds twenty four or thirty two grippers with work-pieces 62. Loaded by grippers, the assembly of removable gripper carrier and latching turret may now be moved to next process stage.

At step 1036 latching turret assembly 60 is attached to disk 536 (see FIG. 6) of rotating fixture 102. Bayonet-type locks 538 facilitate latching turret assembly to disk 536 attachment process. One of grippers, typically positioned over the inspection unit is established as an index or initial counting point for the process at step 1038.

At step, 1040 rough polishing unit 122 (see FIGS. 2, 3, and 4) is activated and its rotating polishing disk 480 (see FIG. 5) is brought in contact with work-pieces 62 mounted in removable gripper carrier 56. A rough polish of the work-piece mounted in the removable gripper carrier is made at step 1042. The rough polishing of the batch of work-pieces mounted in removable gripper carrier 56 at step 1042 is performed by making one full rotation of rotating fixture 102. During this rotation, polishing action continues until at step 1044 the whole batch has undergone preliminary rough polishing.

The preliminary rough polishing action removes materials bonding fiber to ferrule and exposes/cleans fiber or ferrule surface. The exposure of fiber surface enables fiber measurement and orientation process. Following preliminary rough polishing of the batch of work-pieces rotation of rough polishing unit 122 (see FIGS. 2, 3, and 4) is discontinued. Stepwise rotation of disk 536 (see FIG. 6) of rotating fixture 102 (see FIGS. 2 and 8) holding removable gripper carrier 56 is initiated. Each step advances for example removable gripper carrier 510 from one gripper to the next, positioning it over inspection unit 124 (see FIGS. 3 and 8) at step 1046. Inspection unit 124 facilitates angular and elevation work-piece orientation with respect to the desired polishing position. Inspection unit is focused on a work-piece held in a gripper, position of which is known with respect to index gripper. Inspection unit 124 is not refocused for measurements of other work-pieces. Rather the work-piece is adjusted by moving it up or down with the help of micrometric gripper adjustment mechanism 142 to be in the focal plane of inspection unit 124.

Some applications, such as Polarization Maintaining (PM) fibers polishing requires not only high accuracy of the polishing angle, but also a certain orientation of the polarization plane with respect to the polished end-face angle. The typical fiber or ferrule end-face polishing angle for known photonics devices is between 8 and 12 degrees with a tolerance of +/−0.25 degrees. Present angular accuracy of positioning polarization plane of PM type fibers is in the range of +/−3 degrees or less. In order to achieve this accuracy, each of the grippers with work-pieces 62 should be positioned and oriented accordingly. This positioning and orientation process is called “clocking.” Use of preparation station 40 for this purpose allows a significant improvement in polarization plane angular positioning accuracy. A combination of work-piece orientation, with the help of preparation station 40 with subsequent polishing on polishing station 38 of polishing system 36 of the present invention, results in an orientation accuracy of +/−0.1 degree. This is a significant improvement over existing angle measurement methods.

In case of PM fiber polishing at step 1050, gripper with particular work-piece 62, is brought into proper orientation, i.e., is “clocked.” (The fiber clocking process is explained hereinbelow.) The step is repeated for all work-pieces mounted on a particular removable gripper carrier. The process results in all correctly oriented, pre-polished work-pieces with polished surfaces, being brought into a common polishing plane of work-pieces that may be moved to the next step.

Prepared batch data is entered in the computer 42 (see FIG. 1) at step 1054. Based on this data computer 42 generates automatic batch identification code at step 1056. Batch identification code uniquely characterizes the particular batch mounted on a particular portable latching turret assembly 60. The code may have the form of a bar-code label printed by associated printer (not shown) or an electronic code related to a particular batch and portable latching turret assembly parameters. This code identifies a particular batch and work-piece 62 parameters such as type of fiber, type of fiber core, connector, or ferrule attachment, type of AWG, and others. Following this at step 1058, portable latching turret assembly 60 may be removed from preparation station 42 and the system continues to the next batch at step 1060.

At a later stage polished and inspected work-pieces with grippers are removed from portable latching turret 62. Work-piece into gripper insertion device 548 facilitates in work-pieces from grippers extraction process. Use of a number of identical removable work-piece holders streamlines batch processing of large quantities of work-pieces 62. The empty portable latching turret 60 may be once again loaded by work-pieces and used for the next polishing cycle.

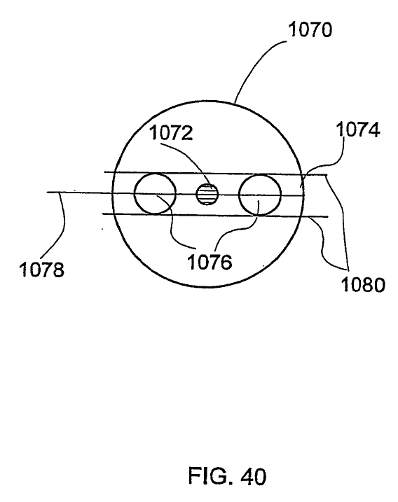

Use and operation of inspection unit 124 for the “clocking” procedure will be explained in detail now. An example of measurement and orientation of a ferrule of a connector with a PM type fiber will be used for explanation. FIG. 40 illustrates a “panda” type polarization maintaining fiber 1070. The fiber core is designated by numeral 1072 and the fiber cladding by numeral 1074. Numeral 1076 indicates so-called stress rods, which are simply preload-providing fibers. Line 1078 in a calibrated preparation station coincides with line 160 (see FIG. 8) or is optionally and preferably parallel to it. Gridlines 1080 displayed on screen of monitor 112 (see FIGS. 2 and 3) are set to be parallel to line 160 and the distance between fixed gridlines is set to match the size of stress rods 1076.

For clocking purposes, gripper 524, for example, is slightly loosened in its position in hole 512 (see FIGS. 8, 9 and 17A), and operator rotates it under the microscope until line 1076 passing through the centers stress rods and fiber core becomes parallel to gridlines 1078, and passes approximately in the middle of the dimension encompassed by them. Following completion of the clocking operation, the gripper is locked once again in removable gripper carrier 510.

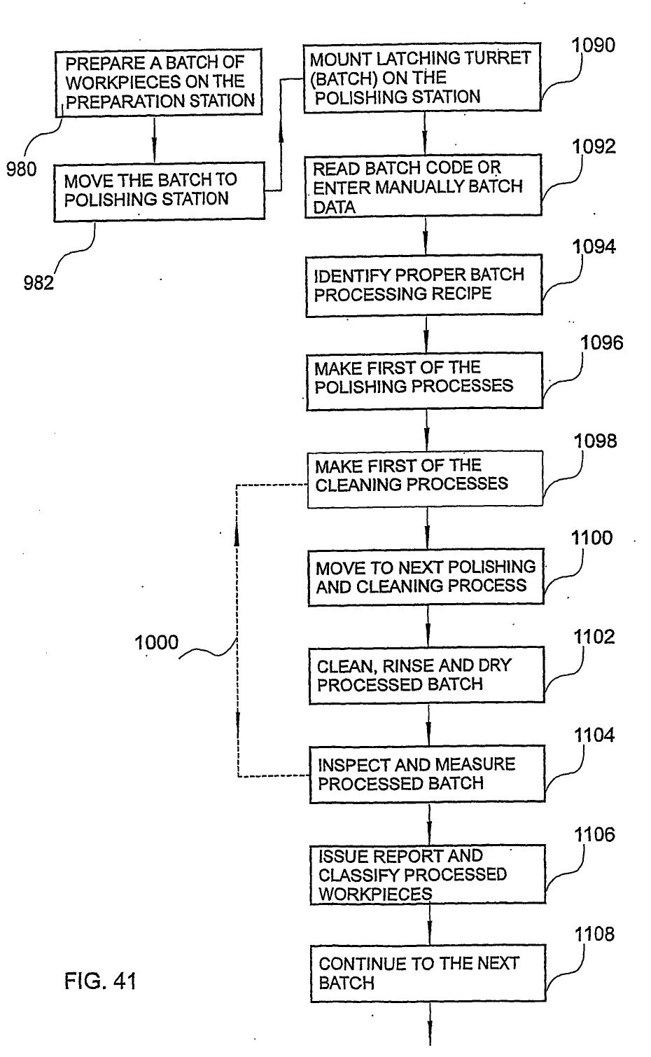

FIG. 41 is a schematic expansion showing in more detail the flow chart of polishing process, cleaning process and initial stages of inspection process and the sequence in which they are performed on the polishing station. At step 1090 portable latching turret assembly 60 is mounted on rigid mount 58 of polishing station 38 (see FIG. 22). An automatic batch identification code is read at step 1092, and according to the batch data, a batch-processing recipe is selected from the recipe database.

The automatic batch identification code may be read by an optical wand, may be communicated via network from preparation station 40 in a case where preparation station 40 has a control computer different from control computer 42, or may be input by other electronic means. Manual entry via graphic user interface of the operator stand 46 may be supported. At step 1094, based on batch data, a proper batch-processing recipe is selected from processing recipes database. The database, in addition to parameters given earlier, may contain such information as type of fiber, desired surface quality, latching turret diameter, spindle rotational and orbital speed, polishing pressure, polishing time at each polishing unit, material grade, etc. The polishing process progresses according to the particular steps selected by control computer 42 recipe. Initially, the first polishing step is accomplished. Following completion of the first polishing stage the batch is cleaned at step 1098 and, if necessary, moved to the next polishing stage at step 1100. Step 1100 may be repeated as required by the particular polishing recipe.

The polishing process is a stable one, and does not require interim inspection and quality assessment of each step, although the polishing system of the present invention supports cleaning, rinsing and inspection after each polishing stage, enabling on-line polishing process control. Should an interim inspection step, marked by broken line 1000, uncover the fact that the batch does not meet the required quality criteria set in the process recipe, a return for rework step will be activated. Based on the assumption of the stability of the polishing process, typically only at the completion of all polishing stages contained in a particular recipe, is the batch moved to the cleaning, rinsing and drying unit at step 1102 for final cleaning and preparation for angular measurements and surface inspection. Batch cleaning, however, optionally may be performed between different polishing steps. Inspection of the processed batch is performed at step 1104. Cleaning, rinsing and drying processes are an important part of both the polishing and inspection process. A cleaning process in between polishing steps is required in order to avoid contamination and damage during the polishing process. Final cleaning is required to evaluate device quality with image processing.

Cleaning is typically performed as a multistage process and it is performed on the whole batch of work-pieces. Initially the surface to be inspected is wetted, and slurry residuals or polishing paper particles are removed from it. This stage takes place when the batch of work-pieces is still on the polishing unit. The next cleaning stage deals with polished surface cleaning and includes use of cleaning units 54 (see FIGS. 21, 26 and 27). The whole processed batch of work-pieces is dipped into a cleaning solution and the cleaning itself may be assisted by mechanical movement of the work-piece or agitation of the cleaning solution. Ultrasonics are typically used for agitation of the cleaning solution.

At the next stage, the cleaning fluid residuals are removed from the work-pieces, the grippers holding them and the gripper carrier. Drying of the polished surfaces of the work-pieces should not leave watermarks on the surface. Watermarks can cause failure of the inspection process. Dried surfaces can be wiped by material that removes particles or watermarks not cleaned by previous operations. A stream of clean air may be used for particle removal purposes also.

Batch inspection parameters may include geometrical dimension measurement, quality of polished surface measurement, angle measurement, etc. Inspection may be manual, semi-automatic or automatic. In all cases, the station operator sets the threshold.

Upon completion of the inspection process, control computer issues a status report at step 1106 enabling the classification of the processed work-pieces 62. Work-piece classification is typically a statistical process, indicating failure probability. Although inspection unit 124 is most effective in batch inspection, individual work-piece measurements may be performed by it.

For each work-piece 62 inspected the report may contain data indicating work-piece 62 name and catalog number, date and time of work-piece 62 inspection, batch identification number, number of components on removable gripper carrier, results of the inspection (pass or fail) and other parameters as defined by user. With the completion of work-piece classification at step 1108, polishing station 38 is prepared to accept the next batch to be processed.

The algorithms and steps of the batch inspection process will be now be described in detail.

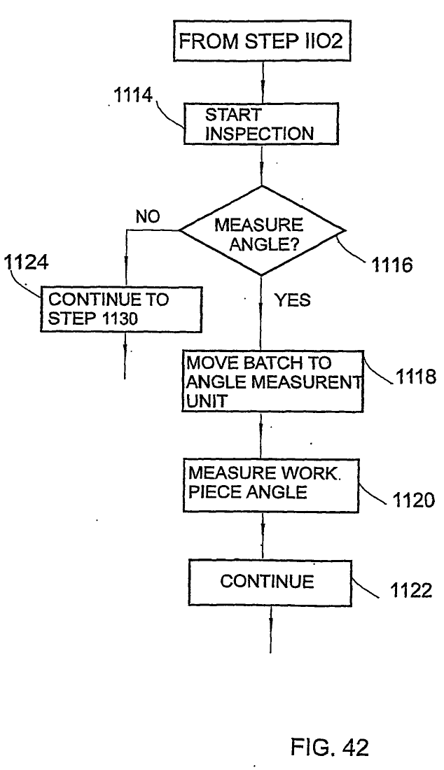

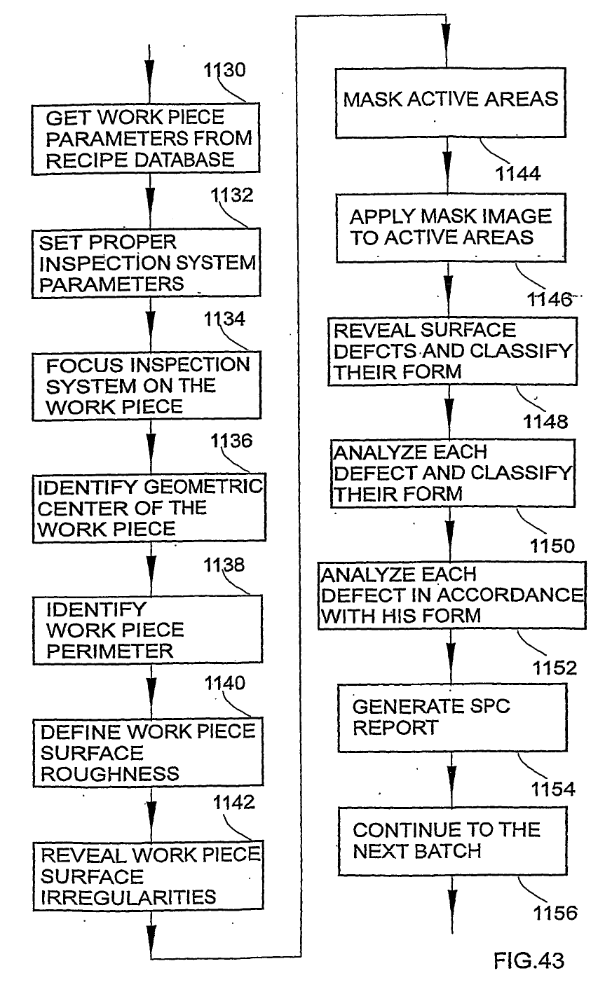

FIG. 42 is a schematic expansion showing in more detail the flow chart of initial stages of inspection processes and the sequence in which they are performed on the polishing station. At step 1114, the batch inspection process begins. At step, 1116 computer/system verifies if angular measurements are required and what type of angular measurement has to be involved. If angular measurements have to be performed by angle measurement sub-unit 382, the batch is moved to it at step 1118. At step 1120 the polished surface angle of each of the work pieces 62 comprising the batch is measured, and measurement data at step 1122 is transferred to step 1154 of FIG. 43. If angular measurements are not required, or the batch is comprised of long work pieces and the same microscope as may measure the polished angle the microscope used for inspection, the algorithm proceeds at step 1124 to step 1130 of FIG. 43.

FIG. 43 is a schematic of a high-level flowchart showing the inspection process steps and algorithm. As indicated, following completion of the polishing processes, the batch of work pieces is cleaned, rinsed, dried and prepared for on-line inspection and dimensions control. Electrical drives are activated and portable latching turret assembly 60 holding a batch of polished and cleaned work pieces is moved on X-Y-Z guides 64, 66, and 68, respectively (FIG. 21, 22, and 23), and positioned in the inspection system area. In accordance with the inspection target control system relative to the Inspection system objectives, the first work piece to be inspected is positioned. Concurrently with the movement of the batch of polished work pieces, computer 42 (FIG. 1), at step 1114, reads the batch identification code and gets the parameters of the work piece to be inspected from the recipe database.

At step 1130 control computer 42 checks if the inspection system magnification matches the recipe inspection targets set for the work piece to be inspected. If any one of the parameters, such as magnification or illumination type and intensity retained from the previous batch inspection do not match the recipe inspection targets, computer 42 sets the proper inspection system parameters at step 1132.

At step 1134 computer 42 focuses the inspection system on the work piece surface. Automatic focusing is done by activating appropriate motor drives moving the removable gripper carrier, and applying the focusing algorithm. The focusing algorithm scans certain work piece areas, sampling their image at different distances from the microscope objective. Actual focusing is done by checking correlation between an image and previous image of the same area taken at different distances/positions of the objective. The position providing the largest correlation value, defined by the largest number of sharpest edges of the image, is considered to be the focus of the inspection system. (A number of focusing algorithms are described in the literature see for example “Robust Autofocusing in Microscopy” by J. Geusebroek et al, Cytometry, V 39, 2000, pages 1-9; “Autofocus for Automated Microassembly Under a Microscope” by S. Allegro et al, IEEE, 1996, pages 677-680 and others.) It is necessary to mention that while all described focusing algorithms perform auto-focusing in a static position, where there is no movement between the microscope and work-piece, the current auto-focusing algorithm operates during scanning of the work-piece. This significantly reduces the batch inspection time, and enables fast and simple polished angle measurement as disclosed above.

Following completion of the inspection system on work piece focusing at step 1136, the geometric center of the work piece may be identified. In order to find the geometric center of a work piece, initially the image of the work piece in one of the video color channels is analyzed. (The actual image analysis is performed on the image provided by one of the video color channels of the CCD video camera.) If the analysis of the image of one of the video color channels, for example the green channel, does not lead to geometric center definition, a “gray” (Actually a 256 level monochrome image.) image is analyzed. This geometric center finding algorithm may be applied to practically any work piece shape, although it is more suitable for circular shapes. Geometric center coordinates for work pieces with circular symmetry may serve as the start point for active area position definition and inspection.

For work pieces with rectangular or polygonal shape (The shape of the work piece is recorded in batch identification code.), a characteristic point on its perimeter may better serve the inspection targets than its geometric center. Accordingly, the algorithm proceeds at step 1138 to identification of the work piece perimeter. The work piece perimeter is found using Hough transformation. For more information on Hough transformation see Hough. P.V.C. “Method and means for recognizing complex patterns.” U.S. Pat. No. 3,069,654, 1962. FIG. 34B shows an arrayed wave guide grating (AWG) work piece, wherein point B designates a point (corner) selected as a starting point for work piece inspection. It should be noted that the coordinate system count may begin at rotation axis 1160 of portable latching turret assembly 60, which coincides with the center of removable gripper carrier 56 as shown in FIG. 35A and the distance count is outwards as indicated by arrow 1200 (FIG. 35A).

With geometric parameters of the work piece known, the algorithm checks if the work piece is suitable for inspection or not. This check is performed at step 1140 by defining the work piece surface roughness. The size and number of irregularities present on the surface define surface roughness. The “top hat algorithm,” provided by Intel Open Source, is applied to one of the video color channels of the work piece's image. The top hat algorithm creates a 256 level histogram and also a smoothed version of it. A logical AND operation between the original histogram and the smoothing curve reveals, at step 1142, the work piece surface irregularities or roughness. The threshold, which is part of the inspection recipe, defines the size of the irregularities revealed. Alternatively, the operator can override recipe recommendations and enter a desired threshold.

Revealed work piece surface irregularities help in marking active areas. These are marked at step 1144. As shown earlier, the image viewed by the inspection system is calibrated in absolute length measurement units, and coordinates of the active areas become immediately known. Active areas are areas where the search for defects takes place. They may be of a number of types, although for explanation purposes they will be limited to rectangular and circular types. For each active area its dimensions and position are recorded. A sample record defining rectangular active area is given below:

Top left corner: X-coordinate, Y-coordinate;

Top right corner: X-coordinate, Y-coordinate;

Bottom left corner: X-coordinate, Y-coordinate; and

Bottom right corner: X-coordinate, Y-coordinate.

Values X and Y in these records are in microns, and the coordinates are counted as explained earlier from the starting point. A similar record for a circular active area may be like the one below:

Radius (Value); and

Center position (X-coordinate, Y-coordinate).

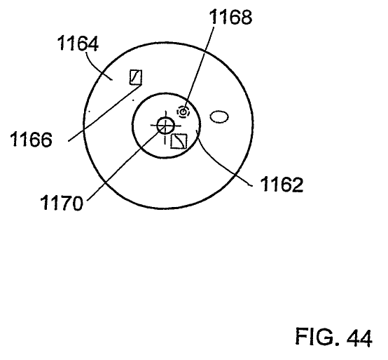

FIG. 44 is an illustration of active areas on a fiber image. It shows a fiber core center, which is marked by numeral 1170, a fiber clad 1162 and a ceramic ferrule 1164. A rectangular active area is marked by numeral 1166 and a circular active area is marked by 1168. Their coordinates are counted from core center 1170 to the corner of rectangular area 1166 and center of circular area 1168.

Active areas are overlaid with a mask image at step 1146 (see FIG. 43) of the processed work piece. Mask image is a synthetically generated image in accordance with earlier defined active areas. Process database keeps mask image of the processed work piece. A logical AND operation between the actual image and mask image at step 1148 reveals present on the surface defects. The defects are classified according to their severity and form as disclosed earlier at step 1150. Defect analyses, according to defect geometrical form, are performed at step 1152 and a statistical process repot is issued at step 1154.

The process is repeated for each known or discovered surface defect and work piece and with completion of batch inspection the inspection of the next batch may be enabled at step 1156.

While the exemplary embodiments of the present invention have been illustrated and described, it will be appreciated that various changes can be made therein without affecting the spirit and scope of the invention

We claim:

1. A high throughput high precision integrated, automated micro-optical and photonics elements polishing system for polishing a batch of work-pieces comprising;
a set-up and preparation station for preparing said batch of work-pieces for polishing;
at least one station for polishing, cleaning, rinsing, drying and inspection of said batch of work-pieces prepared on said preparation station;
a robotic arm for moving said batch of work-pieces between said preparation station and said polishing, cleaning, rinsing, drying and inspection station and within a plurality of positions of said polishing, cleaning, rinsing, drying and inspection station; and
a control computer connected to all said stations and said robotic arm for controlling operation of said polishing system.

2. The polishing system according to claim 1, wherein the preparation station comprises at least one of the following processing means:
batch set-up means for setting up a batch of work-pieces for polishing;
test polishing means for preliminary polishing of said batch of work-pieces to be polished;
batch inspection means for inspecting said preliminary polished batch of work-pieces to be polished;
spatial batch orientation means for positioning in proper spatial orientation said batch of work-pieces to be polished;
batch of work-pieces information generation and coding means for communicating it to said polishing station, and
control computer for controlling said preparation station.

3. The polishing system according to claim 2 and, wherein said batch set-up means comprises:
a portable latching turret for moving said batch of work-pieces between different positions;
a removable gripper carrier for holding grippers loaded with work-pieces;
grippers for holding different work-pieces;
work-piece into gripper insertion means for coupling said work-piece with said gripper;
micrometric gripper orientation adjustment means for assisting in work-piece spatial orientation process, and
said inspection means for facilitating work-piece orientation

4. The polishing system according to claim 3, wherein the removable gripper carrier comprises multiple grippers for holding different work-pieces.

5. The system according to claim 4, wherein said removable gripper carrier comprises separate and suspended, floating gripper mounts.

6. The polishing system according to claim 5, wherein said separate and suspended gripper mounts are attachable to a portable latching turret assembly.

7. The polishing system according to claims 1 and 2, wherein said portable latching turret assembly comprises:
a floating part holding said batch of work-pieces to be polished, and
a rigid part coupled for handling and polishing to said robotic arm.

8. The polishing system according to claim 2, wherein said portable latching turret assembly is a rigid portable latching turret assembly.

9. The polishing system according to claim 2, wherein said portable latching turret assembly is a floating portable latching turret assembly.

10. The polishing system according to claims 2, 7 and 8, wherein said portable latching turret assembly maintains said batch of work-pieces spatial orientation constant through the whole process.

11. The polishing system according to claim 1, wherein said at least one of the polishing, cleaning and inspection stations comprise at least one of the following:
a batch of work-pieces holding and moving means, for holding said batch of work-pieces for auxiliary and operational movements;
a polishing unit for polishing said batch of work-pieces;
a cleaning unit for cleaning said batch of polished work-pieces;
a rinsing and drying unit for rinsing and drying said batch of polished work-pieces;
an inspection unit for inspecting said batch of polished work-pieces;
a digital orbiting movement control unit for orbital movement of said batch of polished work-pieces;
a batch of work-pieces holding means descend speed control means for controlling descend speed of said batch of polished work-pieces;
a force maintenance and monitoring unit for limiting said polishing force applied to said batch of polished work-pieces;
a recipe database for storing and selecting processes to be run on the system;
a SPC type reporting means for reporting results of said polished batch inspection, and
a control computer, for controlling operation of the system.

12. The polishing system according to claim 1, having said at least one of the polishing, cleaning and inspection stations according to claim 11, wherein said batch of work-pieces holding and moving means are digitally controlled and positioned by linearly moving X-Y-Z stages.

13. The polishing system according to claim 1, having said at least one of the polishing, cleaning and inspection stations to according to claims 11 and 12, wherein said linearly moving X-Y-Z stages perform both auxiliary and operational movements.

14. The polishing system according to claim 1, having said at least one of the polishing, cleaning and inspection stations to according to claim 11, wherein said digital orbiting movement control unit creates orbital movement by simultaneously changing polished batch advance speed along X and Y movement stages, and wherein the speed of said X and Y stages may be not equal.

15. The polishing system according to claim 1, having said at least one of the polishing, cleaning and inspection stations to according to claims 11 and 14, wherein said digital orbital movement pattern is achieved by setting the ration between advance speed along X and Y movement stages.

16. The polishing system according to claim 1, having said at least one of the polishing, cleaning and inspection stations to according to claim 11, wherein said polishing unit, said cleaning unit and said rinsing and drying have common external dimensions and their position and order are interchangeable.

17. The polishing system according to claim 1, having said at least one of the polishing, cleaning and inspection stations to according to claim 11, wherein said polishing, cleaning and inspection processes are performed in accordance with said process recipes, and wherein said recipes are stored in a data base.

18. The polishing system according to claim 1, having said at least one of the polishing, cleaning and inspection stations to according to claims 11 and 17, wherein said process recipes database is a hierarchical one comprising:
families, said families including components with similar properties;
components said components characterizing particular work-pieces, and
a plurality of process recipes said recipes containing components processing parameters.

19. The polishing system according to claim 1, having said at least one of the polishing, cleaning and inspection stations to according to claim 17 and where said polishing, cleaning and inspection processes recipes are selected in accordance with said batch identification code assigned at said preparation station.

20. The polishing system according to claim 1, having said at least one of the polishing, cleaning and inspection stations according to claim 11 and where said inspection means comprise:
at least one angle measurement device for measuring polished work-piece angle;
at least one microscope for inspecting polished surface and measuring linear dimensions, and
at least one interferometer for measuring polished surface roughness.

21. The polishing system according to claim 1, having said at least one of the polishing, cleaning and inspection stations to according to claims 11 and 20 and where said at least one angle measurement device for measuring polished work-piece angle is a laser measurement device.

22. The polishing system according to claim 1, having said at least one of the polishing, cleaning and inspection stations according to claims 11 and 20 and where said angle measurement is performed by measuring a reflected laser beam from the surface of a polished work-piece.

23. The polishing system according to claim 1, having said at least one of the polishing, cleaning and inspection stations according to claims 11 and 20 and where said at least one microscope for inspecting polished surface and measuring linear dimensions has bright and dark field illumination and video camera.

24. The polishing system according to claim 1, having said at least one of the polishing, cleaning and inspection stations according to claims 11 and 20 and where said at least one microscope is focused automatically on said polished work-piece surface.

25. The polishing system according to claim 1, having said at least one of the polishing, cleaning and inspection stations according to claims 11 and 20 and where said at least one microscope is focused automatically concurrently with work-piece surface inspection process.

26. The polishing system according to claim 1, having said at least one of the polishing, cleaning and inspection stations according to claim 11, wherein said polishing removal rate is controlled by measuring a batch of work-pieces descend speed.

27. The polishing system according to claim 1, having said at least one of the polishing, cleaning and inspection stations according to claim 11, wherein said force maintenance and monitoring unit limits value of polishing force applied to polished batch of work-pieces.

28. A method of processing a batch of work-pieces of micro-optical and photonics elements for polishing preparation, comprising the further steps of
inserting each of said work-pieces into respective gripper;
mounting each said gripper on a removable gripper carrier and portable latching turret;
moving said portable latching turret with said batch of work-pieces to preparation station;
making rough polishing of said batch of work-pieces;
providing desired spatial orientation to said rough polished batch of work-pieces and placing their respective polished surfaces in one plane; and
generating batch identification information describing said rough polished batch of work-pieces;
wherein said batch identification information describing said rough polished batch is used for further batch processing steps.

29. A method of processing a batch of work-pieces of micro-optical and photonics elements for polishing, cleaning, inspecting and providing a statistical process control (SPC) report, comprising the steps of:
preparing said batch of work-pieces to be polished on said preparation station;
moving said prepared batch of work-pieces to be polished to said polishing, cleaning and inspection station;
communicating/transferring said prepared batch of work-pieces identification information to said polishing, cleaning and inspection station;
selecting polishing process recipe for polishing said prepared batch of work-pieces in accordance said batch identification information;
selecting cleaning recipe for cleaning said polished batch of work-pieces in accordance with said batch identification information;
selecting rinsing and drying recipe for rinsing and drying said polished and cleaned batch of work-pieces in accordance said batch identification information;
inspecting said rinsed and dried batch of work-pieces in accordance said batch identification information, and
providing a pass- fail and SPC report of said inspected batch of work-pieces.

30. A method of processing a batch of micro-optical and photonics elements polishing with removal rate control, comprising the steps of:
preparing said batch of work-pieces to be polished on said preparation station;
moving said prepared batch of work-pieces to be polished to said polishing station;
transferring said prepared batch of work-pieces information to said polishing station; and
selecting polishing recipe for polishing said prepared batch of work-pieces in accordance said batch identification information,
wherein the material removal rate is controlled by said batch of work-pieces descend speed control.

31. A method of polishing material exchange on a polishing system including polishing, cleaning and inspection stations, said method comprising the steps of:
positioning a batch of work-pieces to be polished using a polishing material;
polishing said batch of work-pieces on said polishing material;
monitoring and controlling the linear advance speed of the paired holding means of the work-pieces of said batch of work-pieces; and
setting an optimal range the linear advance speed of the paired holding means of the work-pieces of said batch of work-pieces,
wherein said polishing material change is performed when said batch of work-pieces holding means linear advance speed deviation, exceeds a preset linear advance speed range.

32. A method of processing a batch of work-pieces comprising micro-optical and photonics elements, which are polished and undergo SPC reporting on a polishing system including preparation, polishing, cleaning and inspection stations, said method comprising the steps of:
preparing said batch of work-pieces to be polished on said preparation station;
polishing said prepared batch of work-pieces to be processed on said polishing, cleaning and inspection stations;
cleaning said polished batch of work-pieces on said cleaning station; and
inspecting said cleaned batch of work-pieces on said inspection station,
wherein said SPC report is prepared on-line in accordance with the batch of work-piece inspection results.

33. A method of processing a batch of work-pieces of micro-optical and photonics elements on a polishing preparation station having a plurality of grippers on a removable gripper carrier and a portable latching turret, said method comprising the steps of:
inserting each of said work-pieces into a respective gripper of said plurality grippers of said removable gripper carrier;
mounting each said gripper on said removable gripper carrier and said portable latching turret;
moving said portable latching turret with said batch of work-pieces to said preparation station;
rough polishing of said batch of work-pieces;
providing the desired spatial orientation for clocking of said rough polished batch of work-pieces and placing their respective polished surfaces in one plane;
generating batch identification information describing said rough polished batch of work-pieces,
wherein said batch identification information describing said rough polished batch is used for further batch processing steps; and
using a multiple of said plurality of grippers for different work-pieces with said one removable gripper carrier.

34. The method of processing according to claim 33, comprising the further step of inspecting and analyzing said images.

35. The method of processing according to claim 33, comprising the further step of measuring the polishing angle.

36. The method of processing according to claim 33, comprising the further step of measuring and analyzing said images.

37. The method of processing according to claim 33, comprising the further steps of:
applying a database of experience;
using all of the polishing disk area; and
regulating the polishing speed accordingly.

38. The method of processing according to claim 33, and wherein said removable gripper carrier uses separate and suspended gripper mounts.

39. The method of processing according to claim 33, and wherein the particular invention reduces the number of changes in removable gripper carrier structure by making grippers, holding different form work-pieces, with an identical gripper mounting part.

40. The method of processing according to claim 33, and wherein the first rough polishing is made in a rigid mode of operation and the subsequent polishing steps are made in a floating mode of operation.

41. The method of processing according to claim 33, and wherein the preparation for polishing for all polished surfaces are brought in the same plane.
